(19) United States
(12) Patent Application Publication
(10) Pub. No.: US 2026/0048545 A1
(43) Pub. Date: Feb. 19, 2026

(54) Reactive Resin 3D Printing Composites with Z-Direction Reinforcement

(71) Applicant: NDSU RESEARCH FOUNDATION, Fargo, ND (US)

(72) Inventors: Luke R. GIBBON, Fargo, ND (US); Chad ULVEN, Fargo, ND (US); Dallas PATTON, Fargo, ND (US); Eric HALL, Fargo, ND (US); Kody NEU, Fargo, ND (US)

(21) Appl. No.: 18/749,164

(22) Filed: Jun. 20, 2024

Related U.S. Application Data
(60) Provisional application No. 63/509,342, filed on Jun. 21, 2023.

(51) Int. Cl. B29C 64/209; B29C 64/106; B29C 64/245; B29K 105/00; B29K 303/08; B33Y 30/00

(52) U.S. Cl. CPC B29C 64/209; B29C 64/106; B29C 64/245; B33Y 30/00; B29K 2105/0094; B29K 2303/08; B29K 2995/0012; B29K 2995/0077; B29K 2995/0082

(57) ABSTRACT

A 3D printing reactive extrusion method requires no post cure procedure and provides improvements in the resulting specimen's mechanical properties. A venturi nozzle allows the fiber and resin to be dispensed together. An improved wetout nozzle allows a higher performing composite to be produced and better quality. The improved wetout nozzle better mixes the resin and fiber together so as to remove entrapped air.

### CROSS REFERENCE TO RELATED APPLICATIONS

This application claims priority under 35 U.S.C. § 119 to provisional patent application U.S. Ser. No. 63/509,342, filed Jun. 21, 2023. The provisional patent application is hereby incorporated by reference in its entirety herein, including without limitation: the specification, claims, and abstract, as well as any figures, tables, appendices, or drawings thereof.

### STATEMENT REGARDING FEDERALLY SPONSORED RESEARCH OR DEVELOPMENT

This invention was made with government support under Grant Number W911NF-19-2-0138, awarded by the U.S. Department of Defense—Defense Advanced Research Projects Agency and under Grant Number HQ00342020007, awarded by the National Center for Manufacturing Sciences, Inc., U.S. Department of Defense. The government has certain rights in the invention.

### TECHNICAL FIELD

The present disclosure relates generally to an improved nozzle for 3D printers having applications in at least the additive manufacturing industry. More particularly, but not exclusively, the present disclosure relates to an improved nozzles that allows for Z-directional reinforcement within 3D printed composites, and for similar such nozzles that also allow for increased fiber reinforcement wetout and resin infusion.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Additive manufacturing (AM), also known as 3D printing, is a rapidly growing manufacturing technique that allows for parts to be produced in an efficient manner with minimal tooling and manpower. Additive manufacturing was first developed by Charles Hull in 1987. Hull created the stereolithography (SLA) 3D printer, which utilizes UV light to harden a polymer material layer by layer to form the desired part.

3D printing offers many advantages in the fabrication of composites, including high precision, cost effectiveness and customized geometry. Additive manufacturing can include metals, ceramics, and polymers, however, this study was focused on polymer additive manufacturing. Typically, two forms of polymer 3D printing are used, stereolithography apparatus (SLA) or fusion deposition modeling (FDM). Experiments have been conducted on fiber reinforced 3D printed composites and they can be created from many methods.

SLA is a liquid-based process that consists of curing a photosensitive polymer. A new form of additive manufacturing is emerging, which is printing with reactive thermoset resins. 3D printing with reactive thermoset resins allows for the high properties of a thermoset with little to no post curing necessary.

FDM deposits a semi-liquid thermoplastic material that builds on top of itself to produce the part. Reactive Extrusion Additive Manufacturing (REAM), or reactive resin 3D printing is a new additive manufacturing technique that is being utilized. REAM allows for parts to have higher mechanical properties and a low cure time, making for little to no post processing. There is minimal research published on utilizing REAM with fiber reinforcement to form a composite material, thus making it an attractive research opportunity.

There exists a need in the art for apparatus(es) and method(s) which implement 3D printing reactive thermoset resins and/or continuous reinforcement to build a plate/build volume consisting of Z-directional reinforcement. The apparatus would ideally address fiber introduction issues in all directions of the composite production.

There also exists a need in the art for an apparatus(es) and method(s) which increase fiber reinforcement wetout and resin infusion.

### SUMMARY

A problem occurs where a continuous fiber is introduced into a pressurized resin dispensing system used for additive manufacturing. Reactive resin systems require the mixing or precise amounts of different liquids to initiate the polymer reaction. The resin can be mixed with dynamic mixers which are a series of rotary blades agitating the two or more components into each other to create a homogenous mixer. This type of mixing is often used in high viscosity systems but the mechanical agitation in a chamber eliminates the opportunity to introduce the fiber to the system before that point. Impingement mixing takes the liquid sides and injects them into each other's streams in a small mix chamber and simply the dynamic fluid event mixes the resins together. The high pressure mix chamber is a very brief and violent region and has no opportunity to introduce fiber. Static mixing of the resin is a slow laminar flow of the liquid components flowing over a static mix element that continues to fold and separate the fluid as it travels down the chamber. This mixing option is the most conducive to introducing a fiber into the mix chamber but would still be ill advised as any uneven disturbance in the flow will reduce the quality of the mix and possible trapping of one side of the resin in the fiber itself creating a poor interface.

This leaves the only introduction point of the system to be after the mixing event has occurred. Others have attempted to lay the fiber in front of a dispensed resin but the wetout and continuity to the matrix below the fiber is poor as the resin only wants to flow around the fiber. Other composite manufacturing techniques use a pultrusion method that pulls the fiber through an orifice, but this requires a significant pull force and 3D printing will not have the required pull force as the layers are slowing being deposited and need time to cure.

The solution involves a liquid injection nozzle design based on the venturi principles of fluid dynamics. A venturi or injection nozzle creates a zone of zero to negative pressure in a fluid flow making it possible to use compressed air as a vacuum. This has never before been used in additive manufacturing. The injection nozzle takes advantage of the low-pressure region to introduce and pull the reinforcement fiber into the fluid stream and then again go through a positive pressure region before being dispensed out the nozzle tip. The low-pressure region is required to prevent the back flow of mixed reactive resin which would cure in seconds after back flow and end the print and fiber introduction. A successful design allows the fiber to enter the fluid stream and become fully impregnated with the resin in the positive pressure section before being dispensed on the print bed. There is no other method of introducing a fast-reacting resin to a continuous fiber reinforcement.

The following objects, features, advantages, aspects, and/or embodiments are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to contribute to the small amount of literature and data on the mechanical properties of reactive extrusion additive manufacturing that is presently available.

It is still yet a further object, feature, and/or advantage of the present disclosure to develop a 3D printing reactive extrusion method, that requires no post cure procedure, and to evaluate the resulting specimen's mechanical properties.

It is still yet a further object, feature, and/or advantage of the present disclosure to develop a reactive extrusion additive manufacturing system that can produce different polymer specimens capable of being mechanically tested.

It is still yet a further object, feature, and/or advantage of the present disclosure to evaluate and compare the mechanical properties of the cast and printed versions of each polymer system.

It is still yet a further object, feature, and/or advantage of the present disclosure to include a print bed design consisting of z-direction reinforcement wherein the resin delivery tip can be guided through while printing a thermoset resin and/or continuous fiber.

It is still yet a further object, feature, and/or advantage of the present disclosure to incorporate Z-direction fibers into the print bed allow for improved Z-directional reinforcement, improved interlaminar properties, and a mechanism of pulling/holding a continuous fiber reinforcement through the resin delivery tip. The Z-direction can consist of different fiber types depending on the desired properties. Z-direction fibers improve quality and performance of the resulting composite part and allow for the introduction of a continuous fiber reinforcement along the print head direction.

It is still yet a further object, feature, and/or advantage of the present disclosure to provide better wetout and infusion of resin into the fiber bundle.

It is still yet a further object, feature, and/or advantage of the present disclosure to develop a nozzle design to incorporate fiber into the matrix material for printing.

It is still yet a further object, feature, and/or advantage of the present disclosure to develop printing parameters to successfully incorporate fiber.

It is still yet a further object, feature, and/or advantage of the present disclosure to develop continuous long fiber composites.

It is still yet a further object, feature, and/or advantage of the present disclosure to provide improved nozzle design and printing parameters for continuous fiber introduction into a reactive resin system, the mechanical performance will greatly improve in those materials.

The nozzles disclosed herein can be used in a wide variety of applications. For example, the nozzles can be included in bench top printers and industrial additive manufacturing applications. The nozzles are easy to connect to any reactive resin printing machines and can deliver products that are more suitable for non-prototype applications.

It is preferred that the nozzles be safe, cost effective, and durable. For example, the nozzles can be adapted to resist excessive heat, static buildup, corrosion, and/or mechanical failures (e.g. cracking, crumbling, shearing, creeping) due to excessive impacts and/or prolonged exposure to tensile and/or compressive forces acting on the nozzles.

At least one embodiment disclosed herein comprises a distinct aesthetic appearance. Ornamental aspects included in such a nozzle can help capture a consumer's attention and/or identify a source of origin of a product being sold. Said ornamental aspects will not impede functionality of the nozzle.

Methods can be practiced which facilitate use, manufacture, assembly, maintenance, and repair of the nozzles which accomplish some or all of the previously stated objectives. Such methods would include, for example, the printing of 3D printed composites.

The nozzles can be incorporated into systems or kits which accomplish some or all of the previously stated objectives.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 shows a helical static mix rod, according to some aspects of the present disclosure.

FIG. 2 shows a mix chamber setup with a 152.4 mm pipe, according to some aspects of the present disclosure.

FIG. 3 shows a variable length static mix rod, according to some aspects of the present disclosure.

FIG. 4A shows a 1 mm nozzle cross section, according to some aspects of the present disclosure.

FIG. 4B shows a 3 mm nozzle cross section, according to some aspects of the present disclosure.

FIG. 5 shows an EPL 4 flexural cross section showing excess flow, according to some aspects of the present disclosure.

FIG. 6 shows a system diagram of resin system, according to some aspects of the present disclosure.

FIG. 7 shows a density test setup featuring PX printed specimen, according to some aspects of the present disclosure.

FIG. 8 shows type IV tensile specimen dimensions, according to some aspects of the present disclosure.

FIG. 9 shows a load frame tensile setup, according to some aspects of the present disclosure.

FIG. 10 shows EPL 4 cast tensile results, according to some aspects of the present disclosure.

FIG. 11 shows EPL 4 printed tensile results, according to some aspects of the present disclosure.

FIG. 12 shows PX cast tensile results, according to some aspects of the present disclosure.

FIG. 13 shows PX ideal tensile results, according to some aspects of the present disclosure.

FIG. 14 shows PX non-ideal tensile results, according to some aspects of the present disclosure.

FIG. 15 shows flexural specimen dimensions, according to some aspects of the present disclosure.

FIG. 16 shows a 3-point bend setup, according to some aspects of the present disclosure.

FIG. 17 shows EPL 4 cast flexural results, according to some aspects of the present disclosure.

FIG. 18 shows EPL 4 printed flexural results, according to some aspects of the present disclosure.

FIG. 19 shows PX cast flexural results, according to some aspects of the present disclosure.

FIG. 20 shows PX printed flexural results, according to some aspects of the present disclosure.

FIG. 21 shows a thermogravimetric analysis (TGA) apparatus, according to some aspects of the present disclosure.

FIG. 22 shows EPL 4 cast thermogravimetric analysis results for a first specimen, according to some aspects of the present disclosure.

FIG. 23 shows EPL 4 cast thermogravimetric analysis results for a second specimen, according to some aspects of the present disclosure.

FIG. 24 shows EPL 4 cast thermogravimetric analysis results for a third specimen, according to some aspects of the present disclosure.

FIG. 25 shows EPL 4 printed thermogravimetric analysis results for a first specimen, according to some aspects of the present disclosure.

FIG. 26 shows EPL 4 printed thermogravimetric analysis results for a second specimen, according to some aspects of the present disclosure.

FIG. 27 shows EPL 4 printed thermogravimetric analysis results for a third specimen, according to some aspects of the present disclosure.

FIG. 28 shows PX cast thermogravimetric analysis results for a first specimen, according to some aspects of the present disclosure.

FIG. 29 shows PX cast thermogravimetric analysis results for a second specimen, according to some aspects of the present disclosure.

FIG. 30 shows PX cast thermogravimetric analysis results for a third specimen, according to some aspects of the present disclosure.

FIG. 31 shows PX printed thermogravimetric analysis results for a first specimen, according to some aspects of the present disclosure.

FIG. 32 shows PX printed thermogravimetric analysis results for a second specimen, according to some aspects of the present disclosure.

FIG. 33 shows PX printed thermogravimetric analysis results for a third specimen, according to some aspects of the present disclosure.

FIG. 34 shows a differential scanning calorimetry (DSC) test apparatus, according to some aspects of the present disclosure.

FIG. 35 shows EPL 4 cast differential scanning calorimetry results for a first specimen, according to some aspects of the present disclosure.

FIG. 36 shows EPL 4 cast differential scanning calorimetry results for a second specimen, according to some aspects of the present disclosure.

FIG. 37 shows EPL 4 cast differential scanning calorimetry results for a third specimen, according to some aspects of the present disclosure.

FIG. 38 shows EPL 4 printed differential scanning calorimetry results for a first specimen, according to some aspects of the present disclosure.

FIG. 39 shows EPL 4 printed differential scanning calorimetry results for a second specimen, according to some aspects of the present disclosure.

FIG. 40 shows EPL 4 printed differential scanning calorimetry results for a third specimen, according to some aspects of the present disclosure.

FIG. 41 shows PX cast differential scanning calorimetry results for a first specimen, according to some aspects of the present disclosure.

FIG. 42 shows PX cast differential scanning calorimetry results for a second specimen, according to some aspects of the present disclosure.

FIG. 43 shows PX cast differential scanning calorimetry results for a third specimen, according to some aspects of the present disclosure.

FIG. 44 shows PX printed differential scanning calorimetry results for a first specimen, according to some aspects of the present disclosure.

FIG. 45 shows PX printed differential scanning calorimetry results for a second specimen, according to some aspects of the present disclosure.

FIG. 46 shows PX printed differential scanning calorimetry results for a third specimen, according to some aspects of the present disclosure.

FIG. 47 shows a cross section of PX cast specimen, according to some aspects of the present disclosure.

FIG. 48 shows PX printed specimens with highlighted print path imposed on the photo, according to some aspects of the present disclosure.

FIG. 49 shows an average maximum tensile strength of PX and EPL 4 specimens, according to some aspects of the present disclosure.

FIG. 50 shows an average maximum tensile strength of PX and EPL 4 specimens, according to some aspects of the present disclosure.

FIG. 51 shows average elastic modulus values of PX and EPL 4 specimens, according to some aspects of the present disclosure.

FIG. 52 shows stress-strain curve of cast and printed EPL 4 specimens, according to some aspects of the present disclosure.

FIG. 53 shows stress-strain curve of cast and printed PX specimens, according to some aspects of the present disclosure.

FIG. 54 shows an image of PX printed specimen, according to some aspects of the present disclosure.

FIG. 55 shows flexural stress of PX and EPL 4 specimens, according to some aspects of the present disclosure.

FIG. 56 shows PX flexural specimen leaking pentaerythritol resin, according to some aspects of the present disclosure.

FIG. 57 shows flexural modulus of PX and EPL 4 specimens, according to some aspects of the present disclosure.

FIG. 58 shows a representative TGA curve of each specimen, according to some aspects of the present disclosure.

FIG. 59 shows a representative DSC curve of each specimen, according to some aspects of the present disclosure.

FIG. 60 shows a PX specimen with continuous carbon fiber, according to some aspects of the present disclosure.

FIG. 61 shows a Z-reinforced bed made out of ixtle fibers, according to some aspects of the present disclosure.

FIG. 62 shows a uniform z fiber reinforced bed with continuous carbon fiber printed on top, according to some aspects of the present disclosure.

FIG. 63 shows a section view of a venturi nozzle, according to some aspects of the present disclosure.

FIG. 64 shows venturi effect pipe dimensions, according to some aspects of the present disclosure.

FIG. 65 shows a visual representation of the venturi effect, according to some aspects of the present disclosure.

FIG. 66 shows Type I tensile specimen dimensions, according to some aspects of the present disclosure.

FIG. 67 shows a print set-up, according to some aspects of the present disclosure.

FIG. 68 shows the specimen sample G-code, according to some aspects of the present disclosure.

FIG. 69 shows an inline static mixer (top: Koflo) and the SLA printed static mixer (bottom), according to some aspects of the present disclosure.

FIG. 70A shows a dimensioned drawing of 2 mm venturi nozzle, according to some aspects of the present disclosure.

FIG. 70B shows half-section view of 2 mm venturi nozzle, according to some aspects of the present disclosure.

FIG. 70C shows a dimensioned drawing of 3 mm venturi nozzle, according to some aspects of the present disclosure.

FIG. 70D shows a half-section view of 3 mm venturi nozzle, according to some aspects of the present disclosure.

FIG. 71 shows fiber floating on top of resin bead during single line test.

FIG. 72 shows micro- and macroscopic view of fiber encapsulation.

FIG. 73 shows print grid used to produce multi-layer samples.

FIG. 74A shows a first neat polymer sample, according to some aspects of the present disclosure.

FIG. 74B shows a second fiber reinforced sample, according to some aspects of the present disclosure.

FIG. 74C shows a third fiber reinforced sample, according to some aspects of the present disclosure.

FIG. 75 shows a cross-sectional view of a 2.5 mm diameter nozzle with 4 massage nodes, according to some aspects of the present disclosure.

FIG. 76 shows an end view of a 2.5 mm diameter nozzle with 8 massage nodes, according to some aspects of the present disclosure.

FIG. 77 shows encapsulation of fiber tows with the original nozzle, according to some aspects of the present disclosure.

FIG. 78 shows a noticeable improvement in the encapsulation of fiber tows with the massage-node nozzle of FIG. 75, according to some aspects of the present disclosure.

FIG. 79 shows a bar graph of the flexural strength of printed specimens with basalt and fiberglass introduced, according to some aspects of the present disclosure.

FIG. 80 shows a bar graph of the flexural modulus of printed specimens with basalt and fiberglass introduced, according to some aspects of the present disclosure.

FIG. 81 shows a bar graph of the tensile strength of printed specimens with basalt and fiberglass introduced, according to some aspects of the present disclosure.

FIG. 82 shows a bar graph of tensile modulus of printed specimens with basalt and fiberglass introduced, according to some aspects of the present disclosure.

FIG. 83 shows a 2.5 mm diameter nozzle with 8 nodes, according to some aspects of the present disclosure.

FIG. 84 shows outputs from a 1.5 mm diameter massage nozzle on top with a venturi nozzle on bottom, according to some aspects of the present disclosure.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

Additive manufacturing with polymers can rapidly produce complex geometry and prototypes but does not usually utilize thermoset polymers aside from photocurable polymers. The present disclosure shows and describes two-part reactive thermoset resin systems that were used to additively manufacture parts utilizing a commercially available resin and a custom resin system. Two displacement syringe drivers were used to feed each part of the reactive resin into a mix chamber that utilized a helical static mix rod and was extruded through a 3D printed nozzle. Preferred print parameters were identified and provide the reactive resin specimens with high strength, quick curing, and fast deposition rate. Accordingly, the resin system provides for support structures to be created as well as for overhangs and other additive manufacturing advantages to be realized. The reactive extrusion methods can lead to the utilization of continuous fiber to allow for the creation of complex geometry high performance composites.

### Thermoset Resin Additive Manufacturing

UV Cured Reactive Resins. A common method of producing thermoset polymers via reactive additive manufacturing is accomplished by utilizing photosensitive polymers. Photosensitive polymers, or photopolymers, are polymers that change physical properties when exposed to UV light. The first resins patented for SLA were published in 1989 and 1990. Initially, parts produced with these polymers were inaccurate and were only cured 46%. Acrylate resins exhibited high reactivity but showed low resulting properties which led to the use of epoxide resins. It was found that epoxy resins experienced lower shrinkage and produced higher modulus parts than acrylate resins. Although epoxy resins created harder and more accurate parts, the epoxy resin system also produced brittle parts and the print process was slow. For this reason, common resin systems for SLA systems are an epoxide acrylate combination to allow for accurate rapid production with reduced brittleness. Two advantages of UV cured reactive resins in vat-based photopolymerization techniques are accuracy and surface finish. Given that we have identified preferred laser irradiance depth and scan patterns, the layer height of SLA systems can be as small as 25 microns to allow for excellent surface finish and part accuracy by reducing the gradient between steps. The biggest drawback of vat-based photopolymerization techniques is that the resin systems used have mechanical properties that degrade over time due to aging as well as low impact strength. Another drawback is in the process itself, if the laser is inhibited in anyway, like an obstructed optical window, the resulting part will not be able to optimally cure and thus results in low print quality.

Epoxy Resins. Many groups of reactive resins exist, some of which are epoxy functional resins, phenolic resins, and polyurethane resins. Epoxy functional resins are crosslinked by mixing the epoxy with curing agents. An oligomer containing two or more epoxide groups make up the epoxy side. The curing agent or hardener is usually an amine compound or a diacid compound. Epoxy resins are used for many processes, but one process known as Vacuum Assisted Resin Transfer Molding (VARTM) is a low-cost method to create large composite specimens. VARTM is a liquid composite molding technique that pulls resin through a fiber layup section by using a vacuum to assist in resin transfer through the part. Given that an epoxy resin can have a longer pot life than other polymers, it is used in this process to allow for the resin to wet out the fiber layup prior to gelation.

Epoxy is used in many other processes and industries as well including adhesives, wind turbine composites, and high-performance vehicles applications. Epoxy adhesives, commonly referred to as structural adhesives, have high strength bonds and are used in repairs or construction of bicycles, golf clubs, snowboards, and many more. Epoxy resin has been used to create complex parts via reactive extrusion additive manufacturing. EPON 8111 epoxy resin from Hexion Inc.® mixed with EPIKURE 3271 curing agent also from Hexion Inc.® was used with a volumetric mix ratio of 4:1. Fumed silica by E K Industries Inc.®, CAS No. 112945-52-5 was added at 3.5% by weight to increase the viscosity of the resulting resin. The gel time for this epoxy was 1 minute which helped support additional layers without much deformation. A cool down-period was required before removing parts from the bed because the resin featured an exothermic polymerization reaction. Specimens were created by a 6-layer high specimen that was then cut to size along parallel or perpendicular orientation to the raster direction. The specimens were cut and surfaced using a CNC milling machine.

Phenolic Resins. Phenolic resins result from the reaction of formaldehyde and phenol and are the first truly synthetic commercially available plastic resin. Like many other polymers, phenolic resins have a wide range of applications some of which include ballistics, mass transit, and electronics. Phenolic resins have low thermal conductivity, low density, and high strength to weight ratio among other things. When phenolic resin is combined with Aramid fibers, it creates a strong and tough composite with high impact resistance making it great for ballistic protection applications. The effect of phenolic Aramid composites under ballistic impact was studied and it was found that when the composite has 20% resin content the composite performs better than a composite with 50% resin content. Phenolic resin was blended with neoprene rubber to create thermally stable adhesives. Mass transit vehicles, buses, and trains, have strict fire safety requirements making the phenolic neoprene polymer blend a good candidate for use in the mass transit industry.

Additive manufacturing has been completed using phenolic resins. Silicon carbide was combined with phenolic resin and extruded in an FDM style 3D printer. Without fillers phenolic resins are prone to shrinkage and brittleness. To cure the specimens, heat flow from the bed was used. To increase the effect of the heated bed, the thermal conductivity of the resin system was of interest. The volume fraction of silicon carbide used was 53% and water was also added to reduce the viscosity as it was too high to dispense. The dispensing method was performed via displacement pump on a syringe. The 3D printer was able to produce spiraled hollow geometry that allowed for the use of other heaters to help cure the part.

Polyurethane Resins. Finally, polyurethanes, which are formed by reaction between isocyanate and polyols. The reaction to produce polyurethanes can take place by mixing the two reactants which forms a urethane linkage. A benefit of polyurethanes is that it is not a condensation polymerization which would generate water. Polyurethanes can be tailored for specific mechanical properties. Generally, they are elastic materials with high toughness. However, polyurethanes can be adjusted from high elongation and high energy absorption to have a high elastic modulus and high strength. The mechanical properties can be adjusted by changing the aromatic content of the monomers within the urethane.

Polyurethanes and polyureas have similar components. Polyurethanes are created by combining isocyanates and polyols. Whereas polyureas are created by combining isocyanate with multifunctional amines. Additionally, a hybrid of these two polymers can be created by combining isocyanate with a mixture of polyol and amino groups to provide a blend of characteristics. Specialty Products Inc. features a variety of polyurea with gel times from as low of five (5) seconds to up to nine (9) minutes. Additionally, the polyurea were one hundred percent (100%) solid, and cured at room temperature with no post curing necessary. Kokkinis et al. utilized polyurethane acrylate ink with magnetically responsive particles. A two-component mixer and dispenser were integrated into a 3D printing gantry system. The printer was able to create complex helical structures among other geometry.

Mixing and Dispensing Options. Proper mixing of a two-part polyurethane or polyurea system is crucial. Without an ideal mix the polymer will not be able to fully crosslink and will have reduced mechanical properties. Mixing of the polymer can be performed in different ways, such as impingement, dynamic, and static mixing. Impingement mixing is where two high velocity streams collide with one another and mix during the turbulent flow. Impingement mixing provides a homogenous mix but requires a high velocity between the two fluids which can increase the capital equipment cost. Dynamic mixing can consist of a paddle and a motor, the motor drives the paddle and mixes the polymer. Dynamic mixing can provide a homogenous mixture of high viscosity systems; however, it is an expensive option especially for large scale projects. Static mixing has a low cost because it contains no moving parts and only requires an inline mixer. However, additional costs come from flow metering equipment to control the volume dispensed. The mixer consists of a certain number of elements that create laminar flow and produce irregular paths for the fluids.

Static mixing has many advantages, some include flow, cure, and cost. Static mixing can be used for high viscosity fluids when other mixing options are not applicable. Static mixing does not require high fluid velocity because the mix design consists of mixing elements that are offset 90° from the previous element. This offset disrupts the path of the fluid and causes both fluids to fold over one another until they are homogenously mixed.

Reactive Resin Additive Manufacturing and Composites. Volumetric dosing pumps are used in a variety of industries such as medical technology, adhesives, soldering pastes, cosmetics, and the food industry. ViscoTec (Kennesaw, GA) creates volumetric dosing pumps that allow for materials with viscosity up to 7 kPa*s to be dispensed. Volumetric dosing pumps utilize a progressive cavity pump, which consists of fluid passing through a small sequence of shapes as a rotor is turned. Two-component progressive cavity pumps have been used in bioprinting and 3D printing that incorporates mechanical gradients to produce composite specimens. Additionally, a single component progressive cavity pump has been used to additively manufacture concrete structures.

One prior reactive extrusion additive manufacturing methodology has analyzed the alleged isotropic properties of a print as well as the thermodynamic nature of the exotherm process. The isotropic properties in the tensile direction were reported regardless of print orientation. Only the modulus and ultimate tensile strength showed isotropic results but the elongation at break and toughness were orientation dependent. The printer featured a 214 mm inline helical static mixer and the resin used was a shear thinning epoxy that cured via in situ epoxidation.

A study on 3D printing of lightweight cellular composites featured an FDM style printer with an epoxy-based ink with silicon carbide to create hierarchical structures inspired by balsa wood, yielding an increase of Young's Modulus up to 10 times higher than commercial additive manufacturing thermoplastics. Additionally, the cellulose composite retained comparable strength values 71.1±5.3 MPa. Silicon carbide and carbon fibers were used as fillers aligned in the printing direction. Each filler displayed pullout in the longitudinal specimens and minimal pullout in transverse specimens. Although this study revealed an increase in Young's Modulus, it is expected that continuous carbon fiber will provide higher mechanical properties than the discontinuous fiber that was used in the study.

### Sample Manufacturing & Process Design

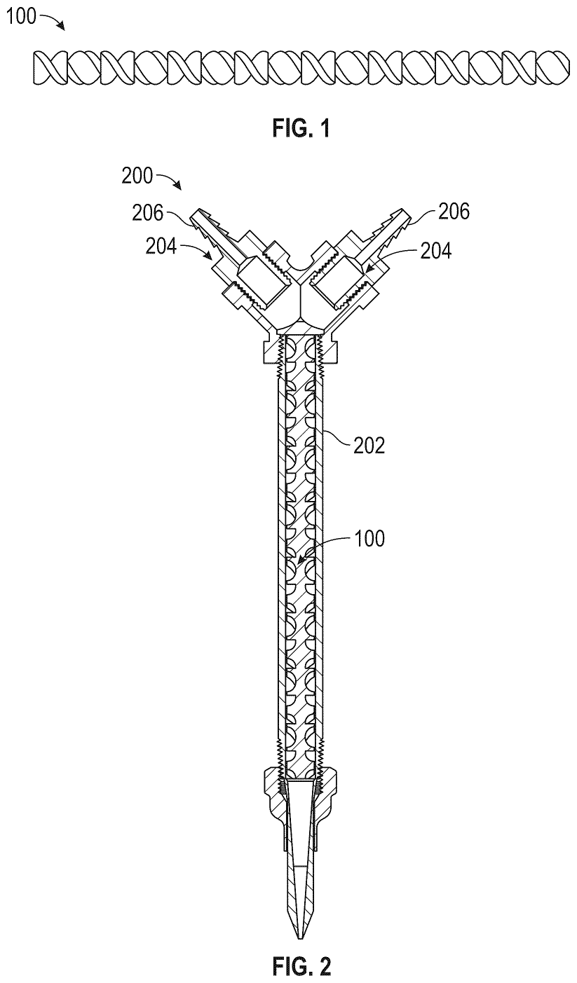

FIG. 1 depicts a helical static mix rod 100 that is designed to be used for this experiment, it features 16 6.25 mm mixing elements in a 101.6 mm section.

The helical static mix rod 100 can be implemented within reactive resin extrusion 3D printers. The 3D-printers can include two volumetric dosing pumps which feed each component into the mixing nozzle. Volumetric dosing pumps work by having a fluid flow into a chamber with an automated screw that dispense the liquid at a certain volumetric rate. Each extruded material exhibited a long cure time that allowed for a continuous network of chemical cross-links throughout the part. Two twin piston positive displacement pumps can dispense two-part reactive resin into a Sulzer Mixpac MS 10-18 T, 214 mm long, and 10 mm inner diameter mix nozzle. Successive layers are deposited and cured rapidly in situ that require no external energy. The effect of orientation on mechanical properties has previously been analyzed.

FIG. 2 depicts a Solidworks CAD model of a mix chamber setup 200. The biggest advantages of static mixing are the low cost and maintaining laminar flow. Other mixing options require equipment to either increase the velocity of the fluid, or to drive the mixing rod to provide an improved mix. To scale up static mixing in industry, the size of the static mix rod 100 increases with the size of pipe 202 used. Depending on the application, static mixer components can be added or removed to integrate into the end user's housing design. Additionally, the static mixer can be tailored for low pressure drop or low-low pressure drop applications.

The 50 mL syringes 204 featured quick-turn connectors 206 that were made from polypropylene to withstand the amine side of the polymer system. Two displacement-based syringe drivers were used to dispense each part of the reactive resin system. Each syringe driver featured a control box that could tailor the displacement speed from 0.01 mm/h to as fast as 2.00 mm/s. The syringe drivers were able to fit syringes from 10 mL to 60 mL. However, the syringe drivers were displacement driven, to determine the rate that needs to be dispensed, the distance needed to dispense (e.g., 1 mL) was recorded and used to create the volume to displacement conversion.

Changes between resin systems required adaptations to the mix chamber as well other components. The changes made to the mix chamber included a variable length mix chamber, variable length helical static mix rod 300, variable speed syringe driver, and a variable nozzle design.

First, the change in mix chamber length allowed more mix elements. With the helical static mix rods 100 being produced via additive manufacturing, this allowed for the number of elements and overall length to be tailored to the resin system that was used.

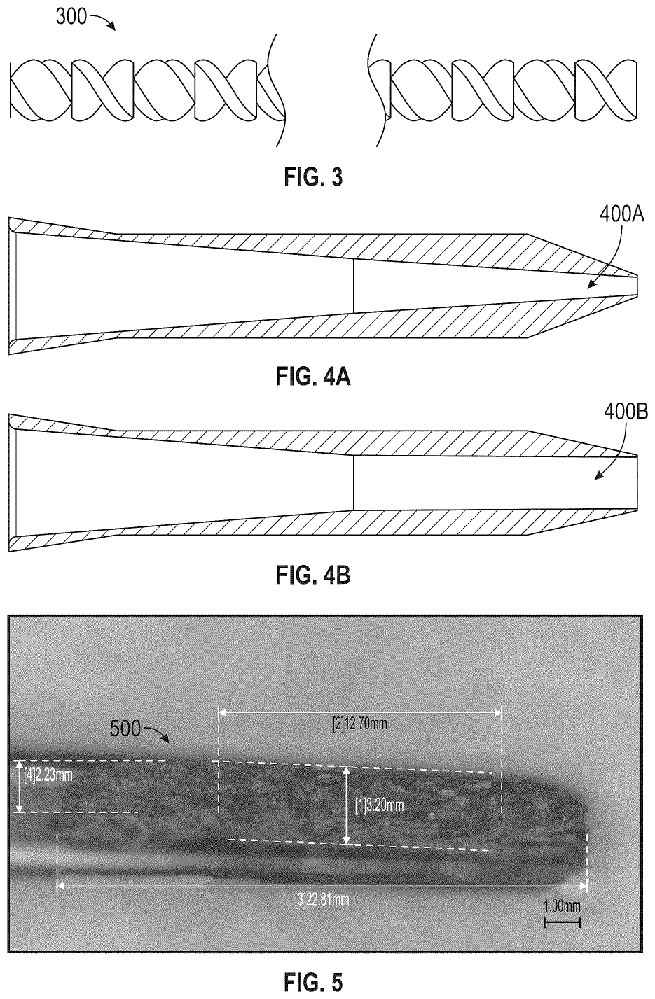

FIG. 3 depicts the engineering drawing of the variable length helical static mix rod 300 including its range of mix elements. Sixteen mix elements were used to print the EPL 4 resin, and 40 mix elements were used to print the custom resin system. Each mix element measured was 6.25 mm in length, width, and height and are offset 90° rotationally from the previous mix element to ensure the fluids fold over one another. Each helical static mix rod was created using Formlabs (Sommerville, Massachusetts) Clear Resin on the Form 2, with a resolution of 50 μm, which is an SLA style printer.

The nozzles were designed to linearly taper down from 6.25 mm to either a smaller cross-section 400A, such as a 1 mm diameter cross-section or a larger cross-section 400B, such as a 3 mm diameter cross-section. Additionally the length of the nozzle is enough to allow for tight fit on the mix chamber outlet and reduce the area of stagnant flow which can be problematic with reactive resins.

To calculate the ratio used between the syringe drivers flow rate and the print head speed, the following equation was used. The volumetric flowrate was calculated for the mix chamber side and was arbitrarily set for the syringe drivers' side, r₁ is the radius of the exit nozzle, then the head speed rate, H, was determined.

$$π {r}_{1}^{2} H = 200 \frac{{mm}^{3}}{sec}$$

The nozzles were produced by the Form 2 with 50 μm print resolution and allowed for a change in nozzle diameter without changing any other portion of the geometry. Increasing the diameter of the nozzle allowed for a reduction of mix chamber pressure and allowed for a higher viscosity resin to flow out without syringe driver failure. The smallest diameter possible was desired to produce a high print resolution. A section view of a 1 mm and 3 mm nozzle is depicted below in FIGS. 4A-4B.

Once a resin system was able to flow through the mix chamber without causing the syringe drivers to fail, then the next stage of the print was able to be evaluated. The syringe drivers would fail either by too much torque needed to continue to dispense the syringe, or the resin would become pressurized in the line and leak from the inlet barbed tube fittings. Observing whether the dispensed material flowing through the system produced a high or low viscosity material was imperative. Viscosity needed to be low enough to flow through the mix chamber with little resistance. However, viscosity then needed to be high enough upon exiting the nozzle to maintain the print shape and have a high print resolution. High viscosity allows for layer buildup and controlled placement. The two parts of the resin system needed to have low viscosity before mixing to reduce the required torque of the syringe drivers. Initially, the print resolution was not of concern and was evaluated after a resin system was developed that could flow through the mix chamber.

Once a resin system was able to successfully dispense through the mix chamber, then the excess flow 500 of the resulting print bead needed to be corrected. Excess flow 500 is the result of a low viscosity material printed on the bed that continued to widen and flatten as it cured. The resin system selected needed to be a low viscosity material inside the mix chamber and increase in viscosity as it exits or shortly after exiting the nozzle. If the resin system was too low in viscosity the printed lines would continue to flow, lowering the overall print resolution as observed in printing with the EPL 4 and shown in FIG. 5. Finally, once a system was developed that provided a print with similar geometric characteristics, with little to no excess flow 500, the Department of Coatings and Polymeric Materials tailored the modulus of the resulting print polymer. A Keyence VHX-7000 (Itasca, IL) was used to capture the image in FIG. 5.

An undesirable resin system produced a geometry with close representation to the G-code but was unable to gel, be dry to the touch, or exhibited a low modulus and thus needed to be changed. After multiple trials of finding solutions to materials gelling and being dry to the touch, it was found that the modulus of the resulting print was not high enough to support its own weight when cantilevered. After a material achieved a high enough modulus, and was able to follow the previously required parameters, then it qualified as a potential material. The resulting useable material was pentaerythritol and m-xylylenediamine, here to referred as PX, with a volumetric mix ratio of 1.125 to 1, respectively.

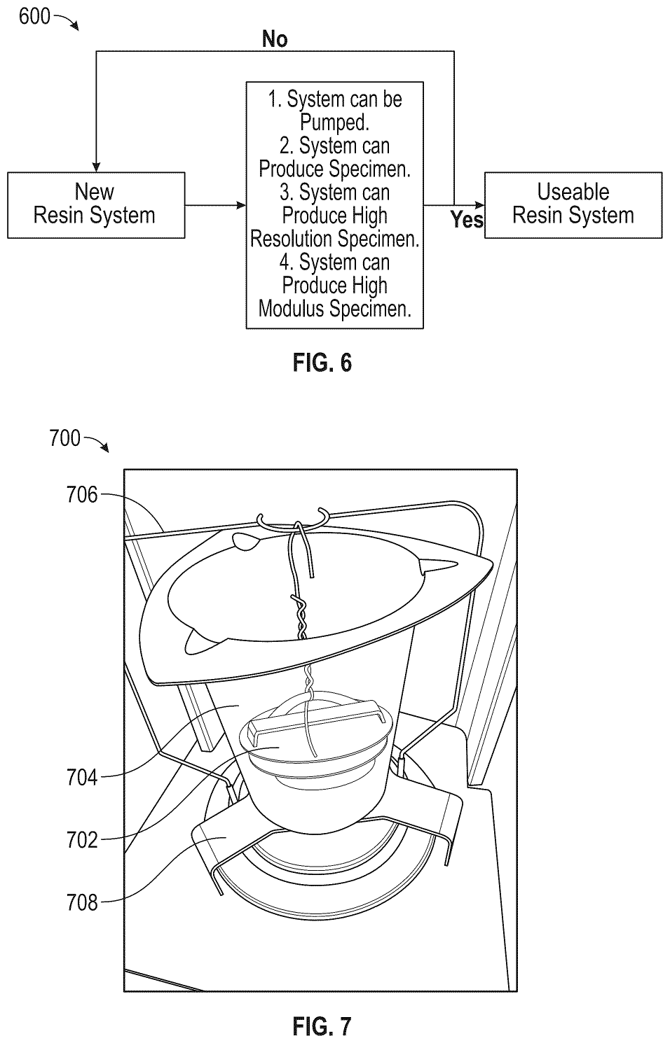

Multiple resin systems needed to be evaluated before the EPL 4 and PX resin systems were selected. Initially, another commercial resin system was selected for the short gel time. It was found that the gel time, in the old commercial system, was too fast to be able to be dispensed. After the commercial resin was selected then the custom resin system was selected. In total, 18 systems were evaluated, and a cumulative list is depicted in Table 1. FIG. 6 exhibits a method 600 to determine a useable resin system.

TABLE 1
Attempted resin systems before EPL 4 and PX.

| Commercial or | | |
|---|---|---|
| custom | Part 1 | Part 2 |
| Specialty Products | Polyshield HT 100F A | Polyshield HT |
| (Commercial) | | 100 F B |
| Custom 1 | 30% Glycerol & 70% Sucrose | DETA 1768 2:1 |
| Custom 2 | 30% Glycerol & 70% Sucrose | DYTEKA 1768 1:3 |
| Custom 3 | 30% Glycerol & 70% Sucrose | DYTREKA 1769 |
| Custom 4 | 30% Glycerol & 70% Sucrose | Ancamine 1769 |
| Custom 5 | 30% Glycerol & 70% Sucrose | Ancamine 2071 |
| Custom 6 | 30% Glycerol & 70% Sucrose | DYTEKA Ancamine |
| | | 2071 1:3 |
| Custom 7 | 30% Glycerol & 70% Sucrose | DYTEKA Ancamine |
| | | 2071 1:3 & |
| | | 2% TEA |
| Custom 8 | 30% Glycerol & 70% Sucrose | 2% Guiacol DYTEKA 2071 |
| Custom 9 | 50% Glycerol & 50% Sucrose | DYTEKA 2071 |
| Custom 10 | 70% Glycerol & 30% Sucrose | 2009 HSF DYTEKA 1:3 |
| Custom 11 | 70% Glycerol & 30% Sucrose | 2007 5% TEA |
| Custom 12 | 70% Glycerol & 30% Sucrose | 2007 DYTEKA 1:3 |
| Custom 13 | 70% Glycerol & 30% Sucrose & | DYTEKA Ancamine |
| | 2% Guiacol | 2071 1:3 |
| Custom 14 | 70% Glycerol & 30% Sucrose & | DYTEKA Ancamine |
| | 2% Guiacol | 2071 1:3 |
| | | 2% TEA |
| Custom 15 | AH-10K Pentaerythritol | DYTEKA Ancamine 1:3 |
| Custom 16 | AH-10K Pentaerythritol | 2007 5% TEA |
| Custom 17 | AH-10K Pentaerythritol | 3-Cyclohexanebis(methylamine) |
| Custom 18 | AH-10K Pentaerythritol | Furandiamine |

### Testing

Density. ASTM D792-20 Method A, which is hereby incorporated by reference in its entirety herein, was followed to test for density of each cast and printed versions of the resin systems. An Ohaus Adventurer™ scale AR2140 (Parsippany, New Jersey) and a Mettler Toledo Density Determination Kit 33360 (Greifensee, Zurich Switzerland) were used in conjunction with a beaker of distilled water and the following equation was used to calculate density.

$${D}_{1} = \frac{a}{a - {b}_{1}} * {ρ}_{W}$$

where D₁ is density, a is the dry mass of the polymer, b₁ is the apparent mass of the completely immersed specimen and pw is the density of water at 20.4° C. The density of water at 20.4° C. is 998.15 kg/m³. First, the apparent mass of the specimen was found, the specimen was left on the scale for five (5) minutes to balance out before recording mass and removing. After the apparent mass of the specimens were recorded, the apparent mass of the completely immersed specimens needed to be measured. To measure the apparent mass of the completely immersed specimens the dry specimen was put on the specimen holder and submerged in the immersion vessel. Again, the specimen was left undisturbed for five (5) minutes before recording the apparent mass of the completely immersed specimen completely.

FIG. 7 depicts a density test setup 700 where the PX printed specimen 702 is placed inside the apparatus 704. The PX printed specimen 702 is hung from an upper frame member 706. The apparatus 704 rests on a base/support 708.

Tensile. A load frame 900 (Instron 5567: Norwood, Massachusetts), equipped with a load cell 902 (2 kN load cell), was used to test tensile properties of the specimens. A 25.4 mm extensometer was used on all cast specimens, however the extensometer values needed to be divided by 50.8. This was because the test input read the extensometer as a 50.8 mm extensometer rather than a 25.4 mm extensometer. An extensometer was not used on the printed specimens, to monitor strain because securing it to the specimens would cause premature failure by introducing a stress concentration in the gauge section. Strain was calculated by dividing the extension by the gauge length. The ASTM standard referenced for tensile testing was ASTM D638-14, which is hereby incorporated by reference in its entirety herein. The crosshead rate of the load frame was set at five millimeters per minute (5 mm/min). The specimen sizes were type IV for the neat resin specimens and dimensions are in millimeters.

The equation below and a minimum of 5 specimens of each type was used per the ASTM standard.

$$E = \frac{{σ}_{T}}{{ε}_{T}}$$

where E is the modulus of elasticity, σ_{T} is the tensile stress, and ε_{T} is tensile strain. The tensile stress and tensile strain values should be taken from the linear portion of the stress-strain curve.

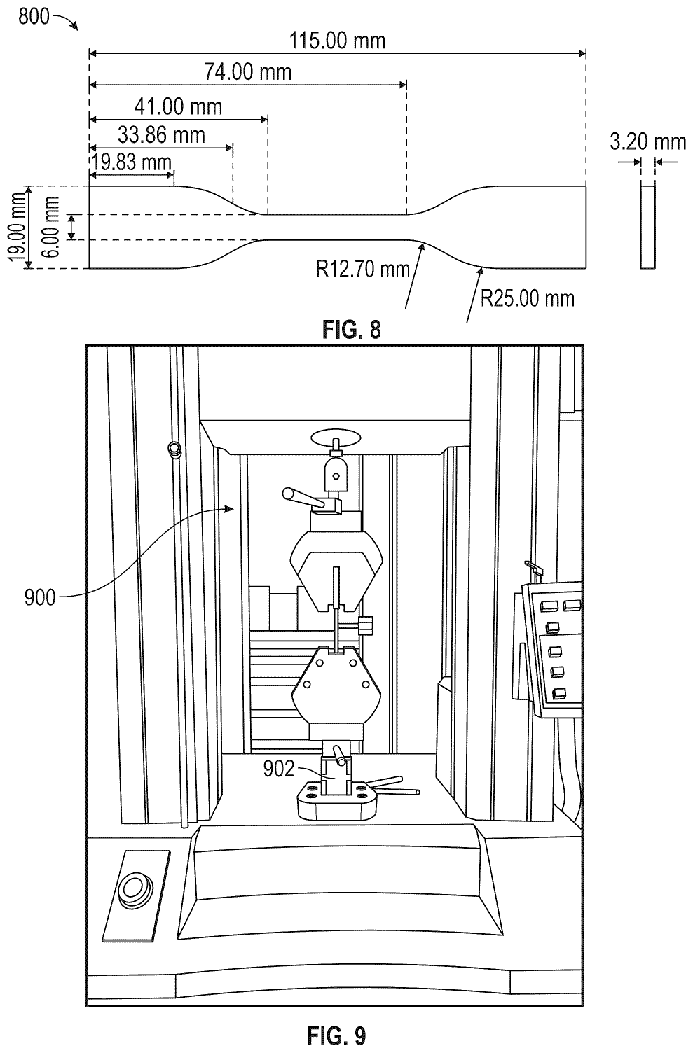

Type IV is meant for nonrigid, plastic specimens 800. The dimensions of the dog-bone shaped specimens 800 are shown in FIG. 8.

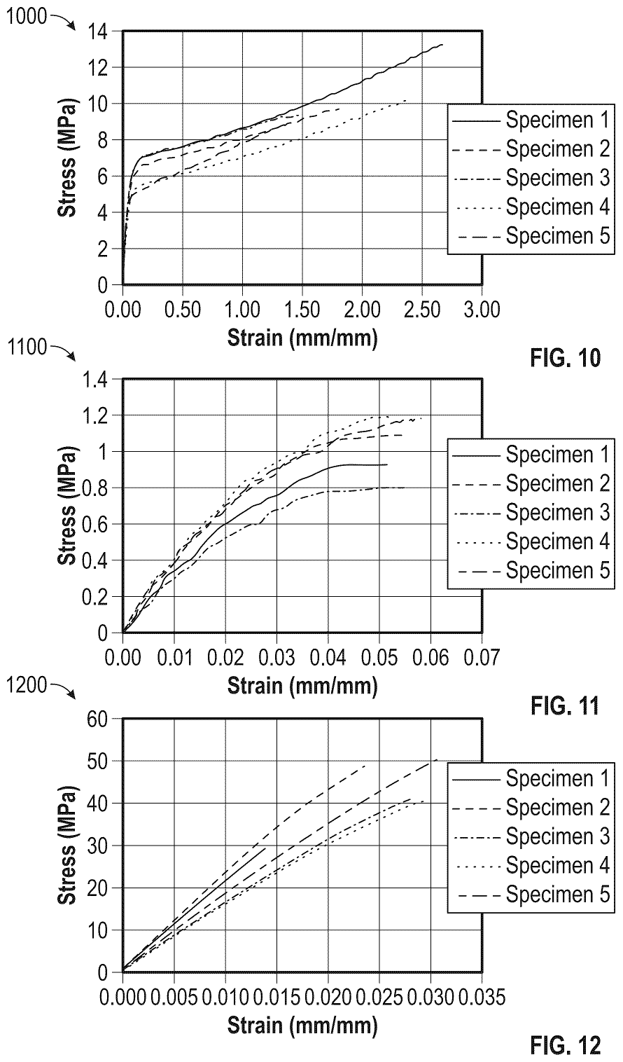

The Instron 5567 load frame setup 900 for tensile testing is shown in FIG. 9. Tensile testing was completed to find engineering tensile strength and strain to failure, the results of which being shown in FIGS. 10-14. Each specimen was preloaded with approximately 1 N to ensure the specimens were in tension prior to testing.

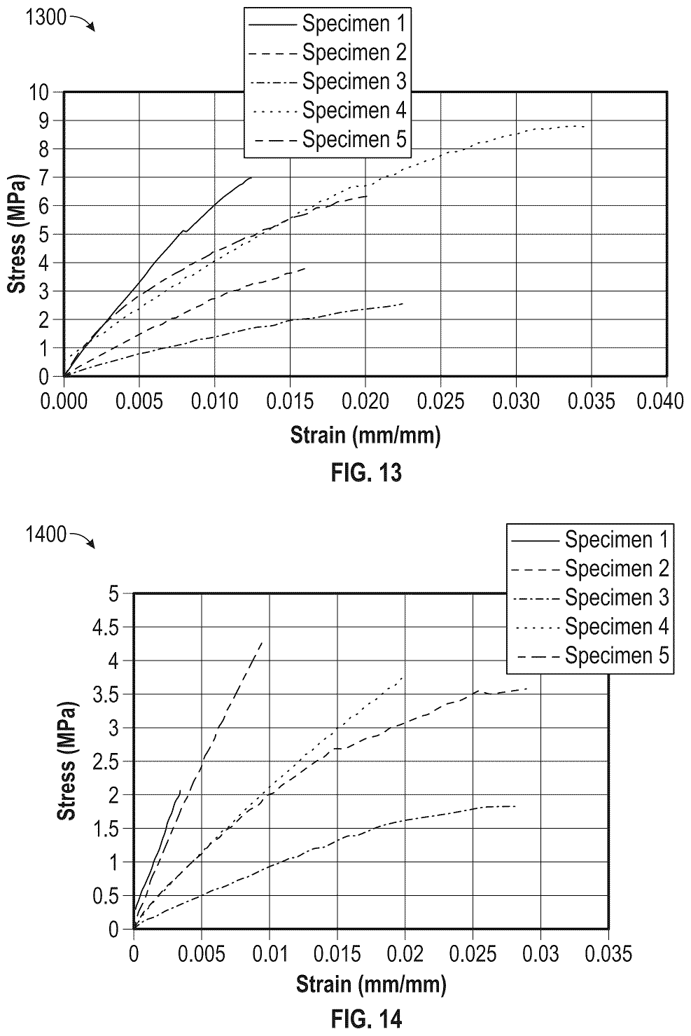

FIG. 10 shows EPL 4 cast tensile results 1000. FIG. 11 shows EPL 4 printed tensile results 1100. FIG. 12 shows PX cast tensile results 1200. FIG. 13 shows PX ideal tensile results 1300. FIG. 14 shows PX non-ideal tensile results 1400.

Flexural. Flexural testing was performed to determine flexural strength, and flexural modulus. The flexural test procedure was completed in accordance with the ASTM D790-17 standard, which is hereby incorporated by reference in its entirety herein. The test utilized an Instron 5567 load frame, equipped with a 2 kN load cell. Since the specimens were neat, and did not contain reinforcement, the 3-point bend flexural testing was concluded at 5% strain or failure per the standard. The crosshead rate was calculated from Equation 5.3.

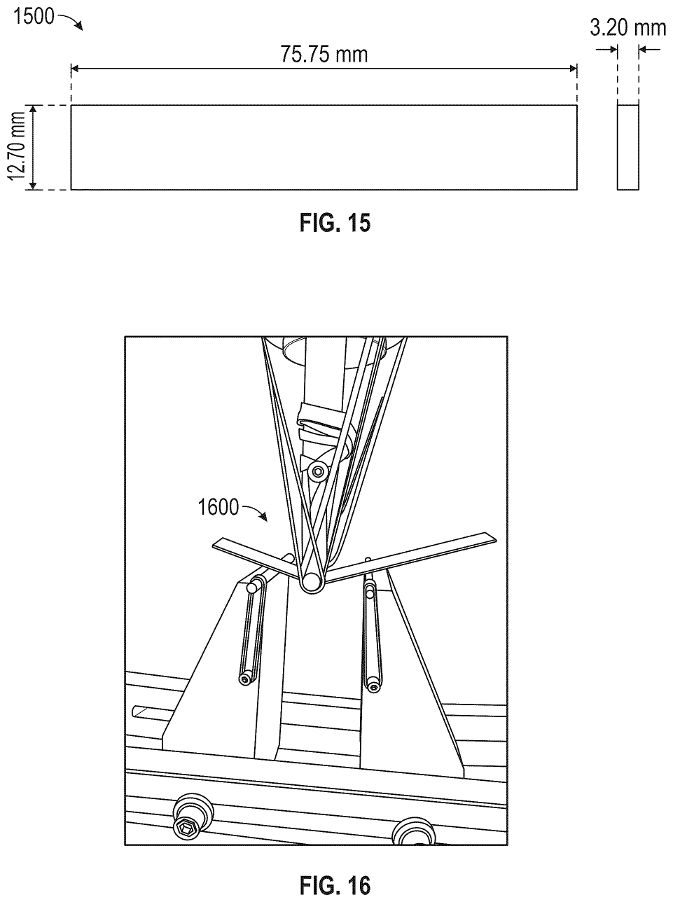

FIG. 15 depicts the specimen dimensions in mm. At least 5 nonrigid, plastic specimens 1500 per resin system were tested per the standard.

Crosshead rate was calculated using the following equation:

$$R = \frac{{ZL}_{2}}{6 d}$$

where R is crosshead rate, L is support span, d is depth of beam, and Z is rate of straining of the outer fiber. Z was equal to 0.01 per the ASTM standard.

The theoretical deflection at which 5% strain will occur was calculated from the following equation.

$$D = \frac{{rL}^{2}}{6 d}$$

where D is the midspan deflection, r is strain, L is support span, and d is depth of the beam.

The theoretical midspan deflection was calculated to be 14.94 mm. Flexural stress was calculated from the following equation.

$${σ}_{f} = \frac{ePL}{2 {bd}^{2}}$$

where σ_{ƒ} is stress in the tension section of beam at midpoint, P is the load given at a point on the load-deflection curve, L is support span, b is width of beam, and d is depth of beam.

Flexural strain was calculated from the following equation.

$${ε}_{f} = \frac{6 Dd}{{L}^{2}}$$

where ε_{f} is strain in the outer surface, D is maximum deflection of the center beam, L is support span, and d is depth of beam.

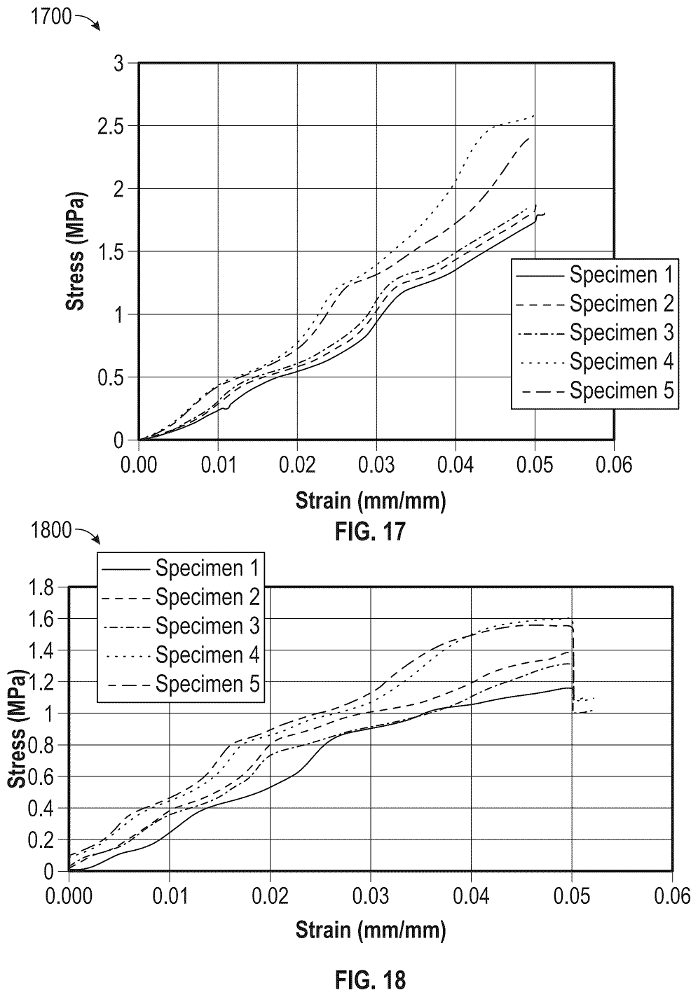

Chord modulus was calculated from the following equation.

$${E}_{f} = \frac{{σ}_{f 2} - {σ}_{f 1}}{{ε}_{f 1} - {ε}_{f 2}}$$

where E_{ƒ} is the chord modulus, σ_{ƒ1} and σ_{ƒ2} are flexural stresses measured at predefined points on the load-deflection curve, and ε_{ƒ1} and ε_{ƒ2} are flexural strains measured at predefined points on the load-deflection curve. The Instron 5567 setup for 3-point bend testing 1600 is depicted below in FIG. 16, and the results from said testing are shown throughout FIGS. 17-20.

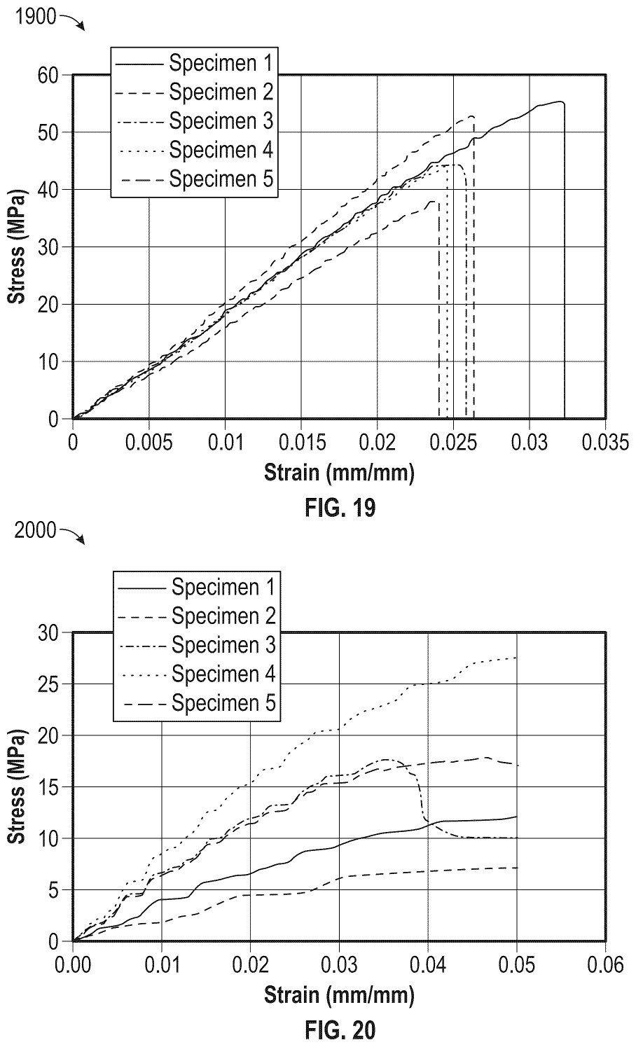

FIG. 17 shows EPL 4 cast flexural results 1700. FIG. 18 shows EPL 4 printed flexural results 1800. FIG. 19 shows PX cast flexural results 1900. FIG. 20 shows PX printed flexural results 2000.

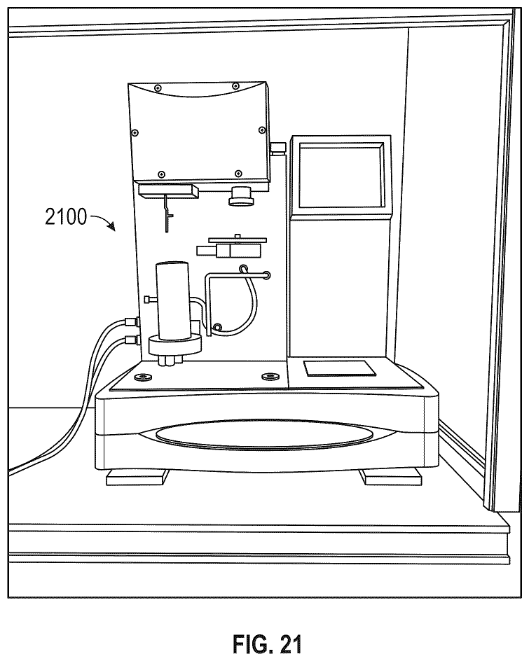

Thermogravimetric Analysis. Thermogravimetric analysis, TGA, of the specimens was completed in reference to ASTM D3850-19, which is hereby incorporated by reference in its entirety herein. Testing was performed on a TA TGA Q500 (New Castle, Delaware) to determine the thermal degradation temperature for each resin system. Thermal degradation temperature was required before performing differential scanning calorimetry, DSC. This was because DSC test equipment can be damaged if the specimen degrades while being tested. TGA was executed in conjunction with NDSU's Department of Coatings and Polymeric Materials. A TGA apparatus 2100 (e.g., the TGA Q500; TA Instruments: New Castle, DE) is shown in FIG. 21.

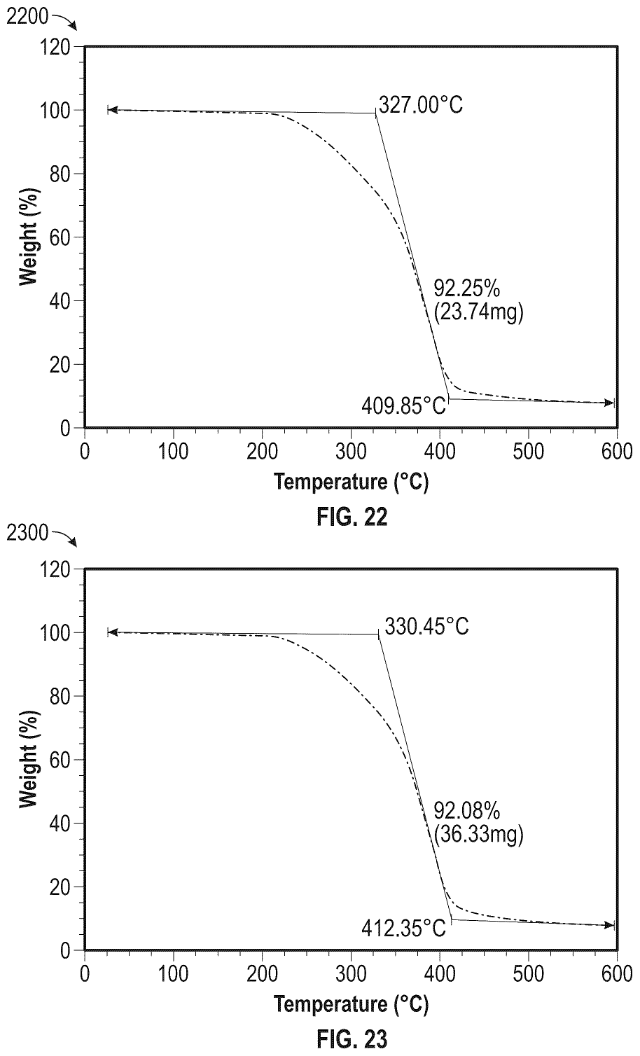

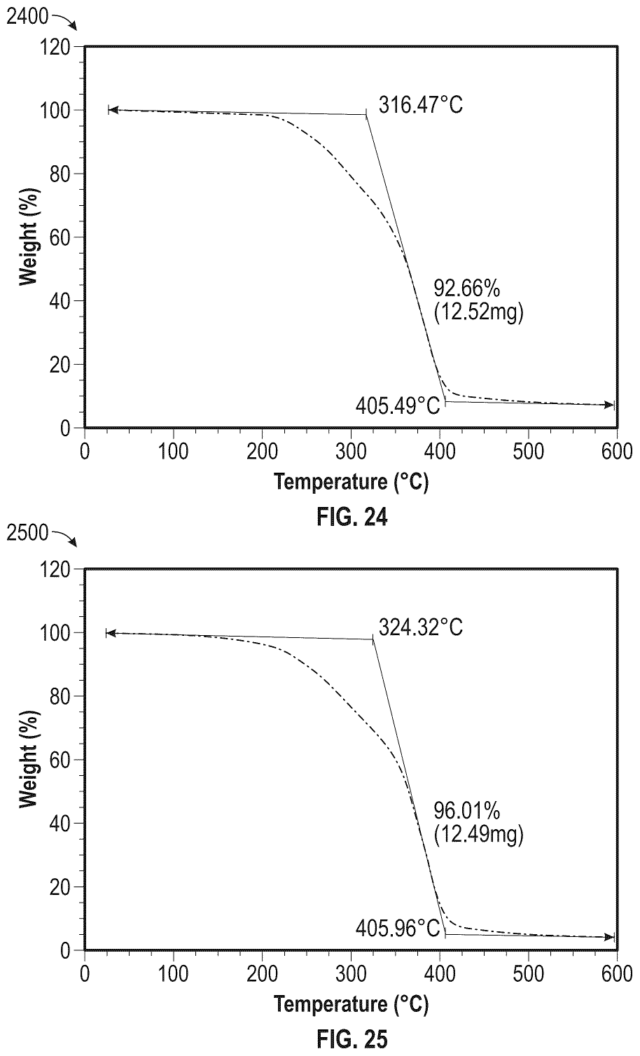

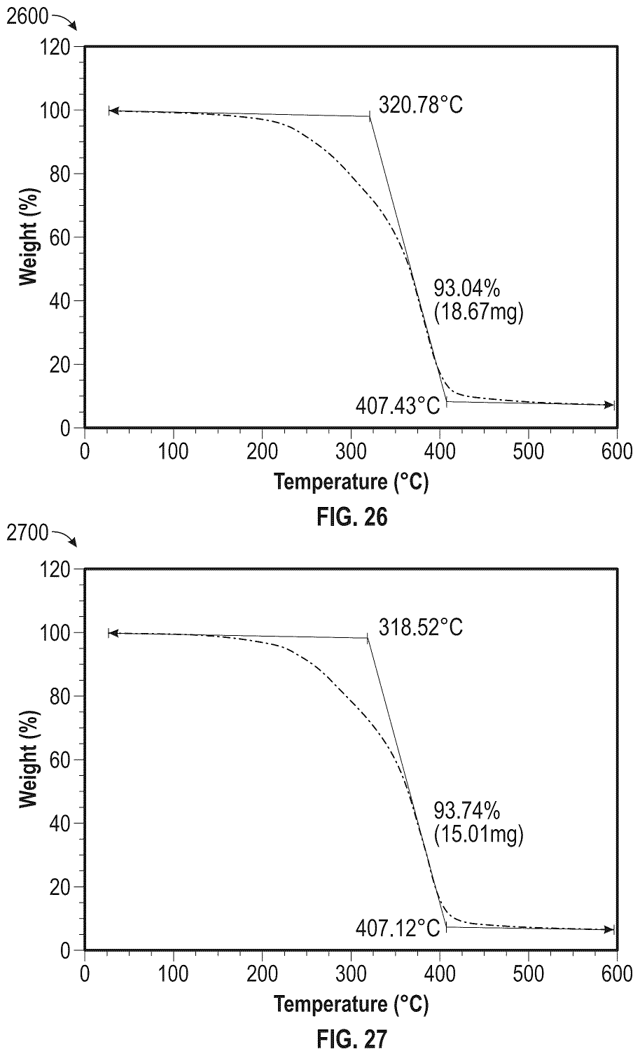

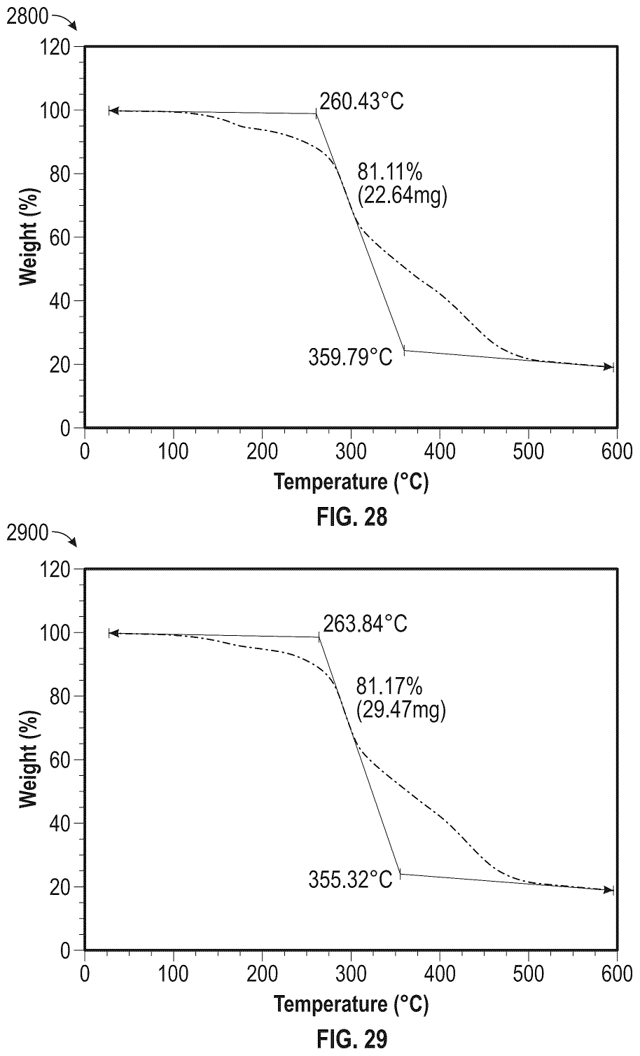

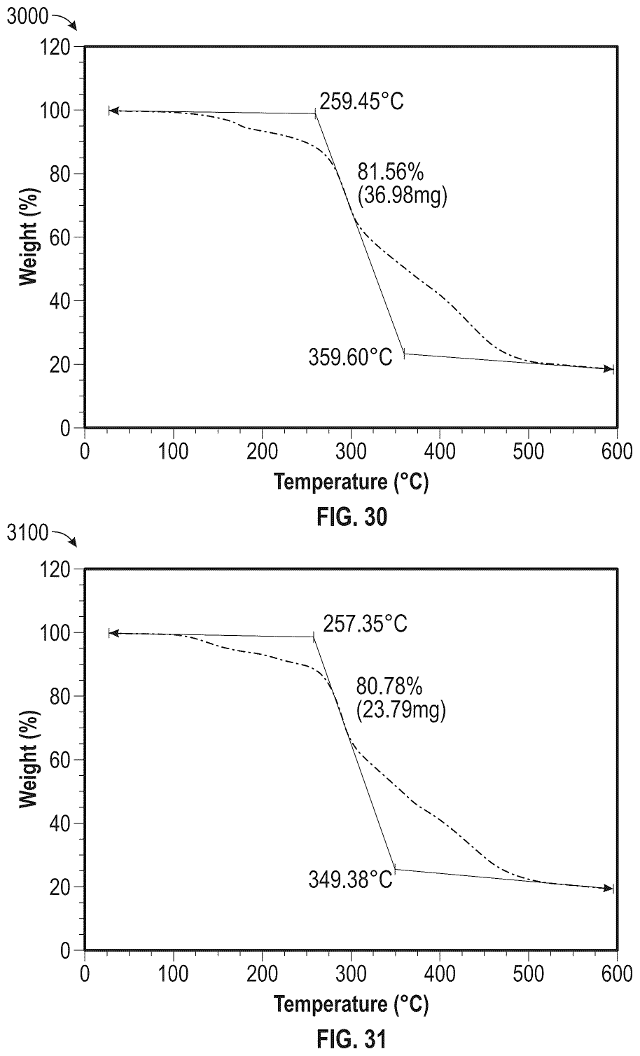

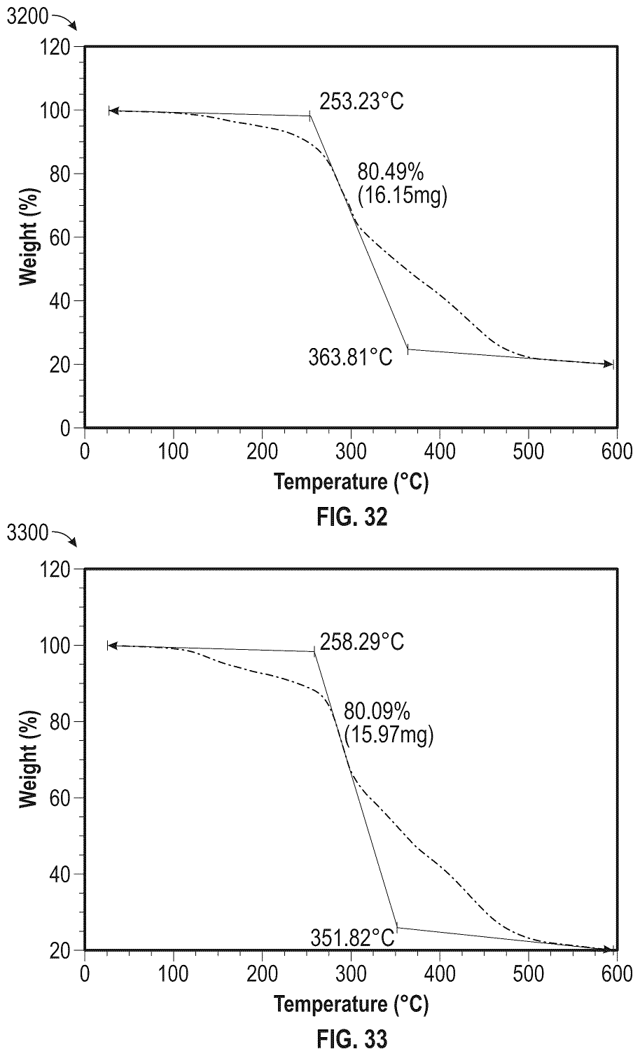

FIG. 22 shows EPL 4 cast specimen 1 TGA results 2200. FIG. 23 shows EPL 4 cast specimen 2 TGA results 2300. FIG. 24 shows EPL 4 cast specimen 3 TGA results 2400. FIG. 25 shows EPL 4 print specimen 1 TGA results 2500. FIG. 26 shows EPL 4 print specimen 2 TGA results 2600. FIG. 27 shows EPL 4 print specimen 3 TGA results 2700. FIG. 28 shows PX cast specimen 1 TGA results 2800. FIG. 29 shows PX cast specimen 2 TGA results 2900. FIG. 30 shows PX cast specimen 3 TGA results 3000. FIG. 31 shows PX print specimen 1 TGA results 3100. FIG. 32 shows PX print specimen 2 TGA results 3200. FIG. 33 shows PX print specimen 3 TGA results 3300.

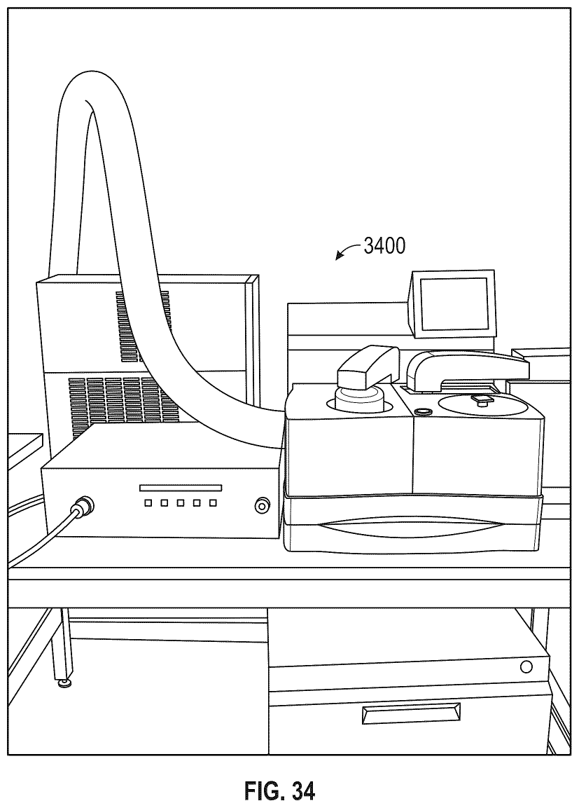

Differential Scanning Calorimetry. Differential scanning calorimetry, DSC, was performed on a DSC test apparatus 3400 (TA DSC Q1000; TA Instruments: New Castle, Delaware) and in reference to ASTM E2160-04, which is hereby incorporated by reference in its entirety herein. An empty tray was weighed and compared to each of the specimens by determining the difference in energy absorption through temperature change. DSC was completed to determine the glass transition temperature, and degree of cure of the polymer. A lower glass transition temperature indicates a lower amount of cross-linking and requires a colder temperature to keep unlinked polymer chains out of their free state. Degree of cure was important to prove the homogeneity of the mixture completed by the static mixing rod during the printing process. DSC was completed three times for each type of specimen. The DSC apparatus 3400 is shown in FIG. 34.

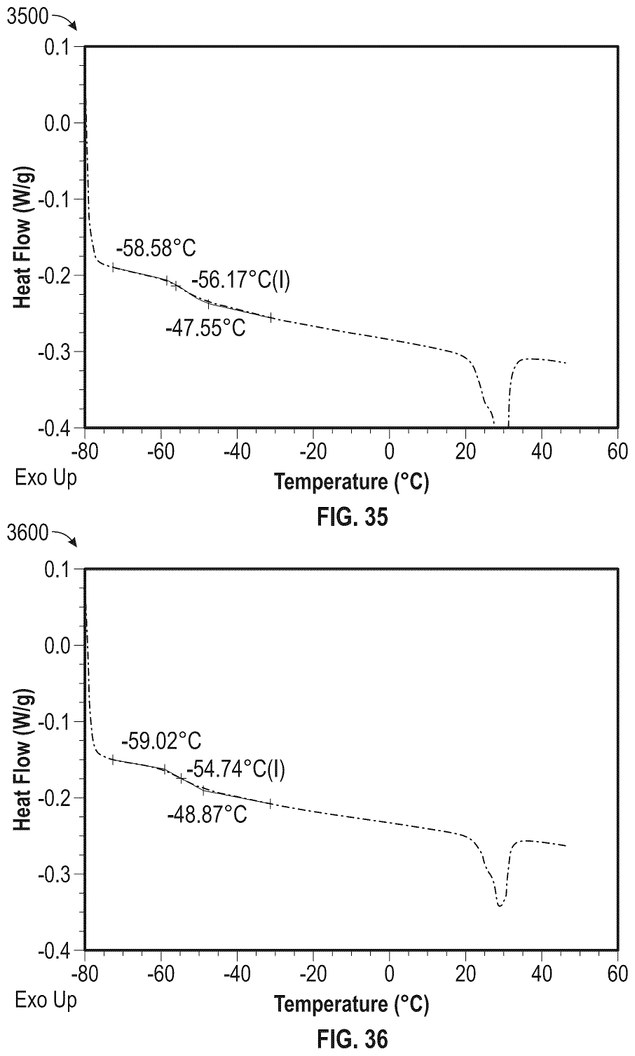

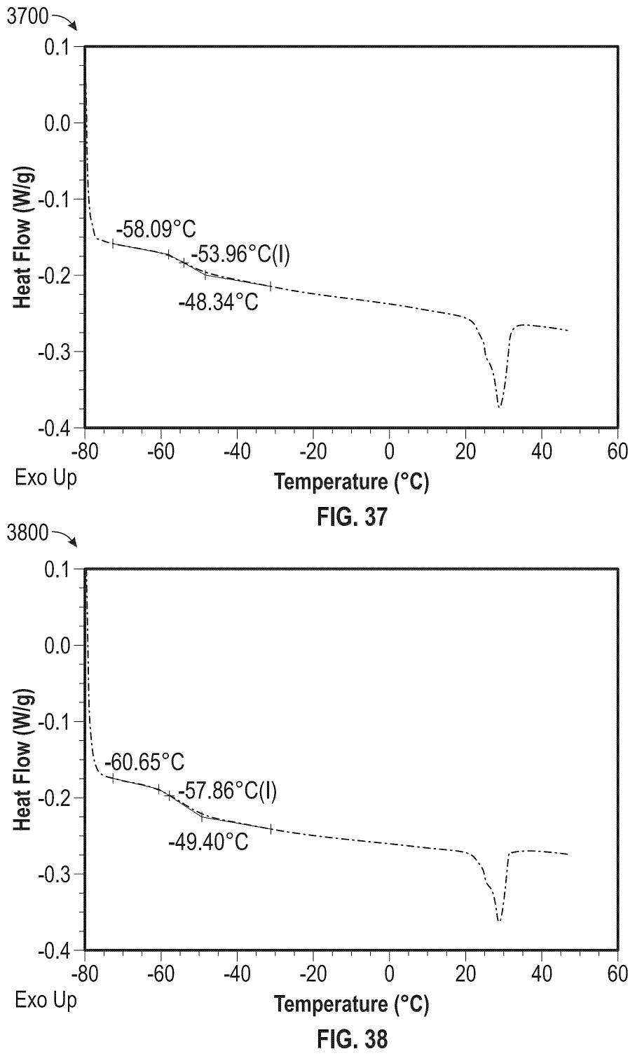

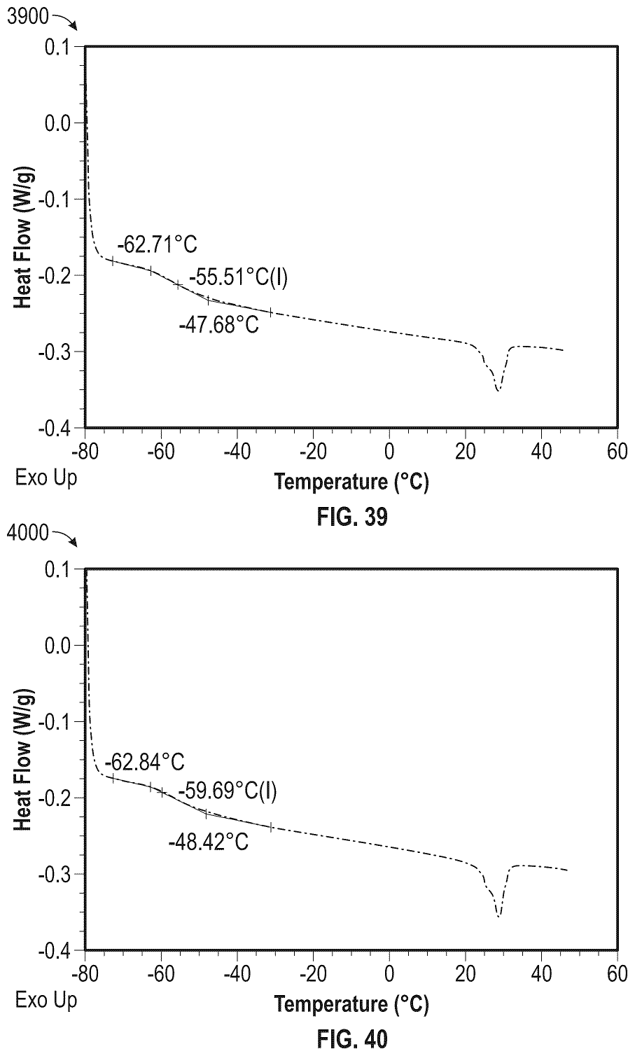

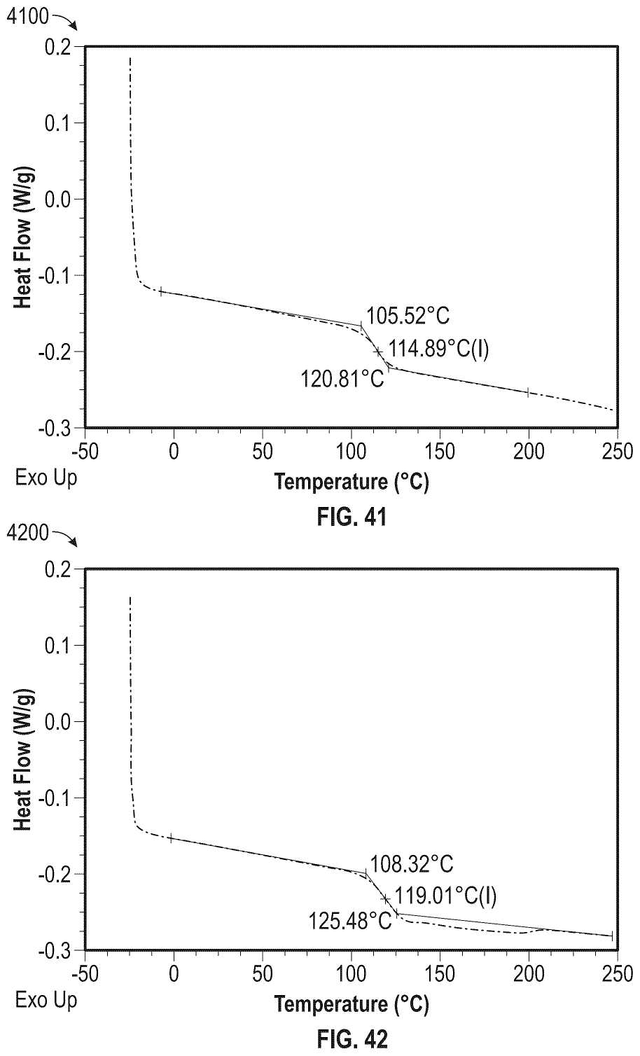

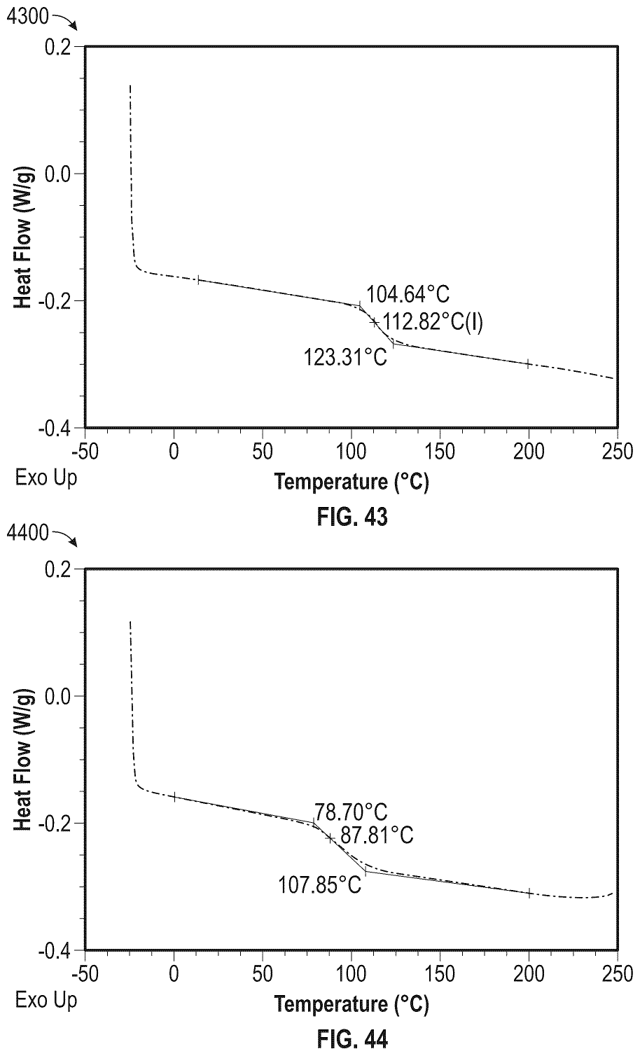

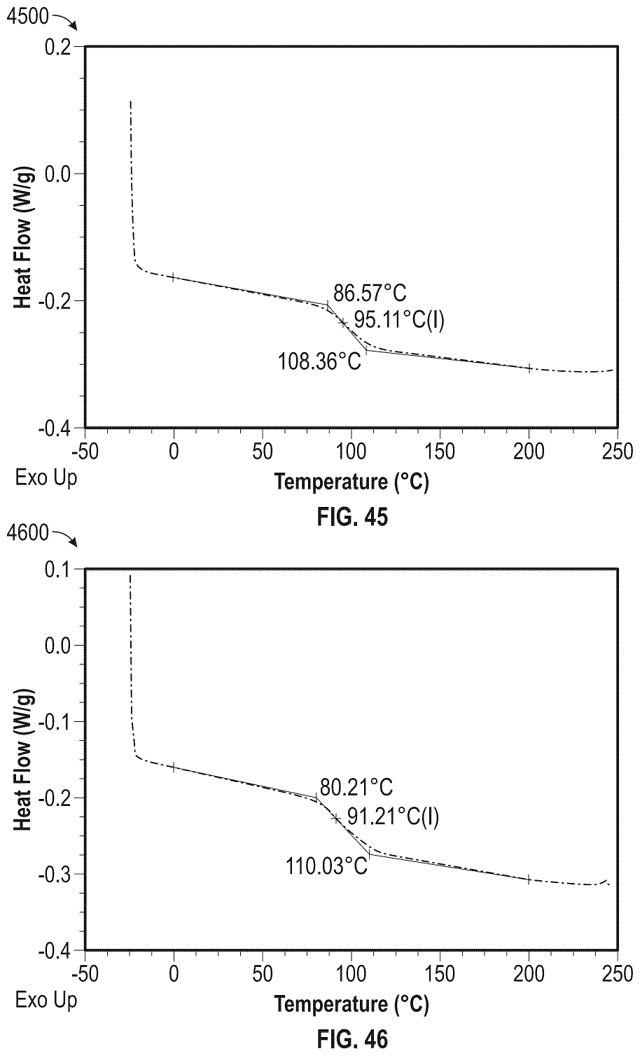

FIG. 35 shows EPL 4 cast specimen 1 DSC results 3500. FIG. 36 shows EPL 4 cast specimen 2 DSC results 3600. FIG. 37 shows EPL 4 cast specimen 3 TGA results 3700. FIG. 38 shows EPL 4 print specimen 1 TGA results 3800. FIG. 39 shows EPL 4 print specimen 2 TGA results 3900. FIG. 40 shows EPL 4 print specimen 3 TGA results 4000. FIG. 41 shows PX cast specimen 1 TGA results 4100. FIG. 42 shows PX cast specimen 2 TGA results 4200. FIG. 43 shows PX cast specimen 3 TGA results 4300. FIG. 44 shows PX print specimen 1 TGA results 4400. FIG. 45 shows PX print specimen 2 TGA results 4500. FIG. 46 shows PX print specimen 3 TGA results 4600.

### Results and Discussion

Density. Density testing was completed for each specimen of both resin systems. The specimens sank once fully immersed in distilled water which negated the use of a sinker. The temperature of the distilled water was 20.4° C. and the immersion vessel was a 400 mL beaker. Specimens were prepared by being cut to a small enough size to fit on the sample holder. Table 2 depicts the density values of PX and EPL 4 cast and print specimens.

TABLE 2
Density values of each specimen.

| Specimen | Density (g/cm³) |
|---|---|
| PX Cast | 1.150 ± 0.007 |
| PX Printed | 1.155 ± 0.006 |
| EPL 4 Cast | 1.072 ± 0.010 |
| EPL 4 Printed | 1.009 ± 0.005 |

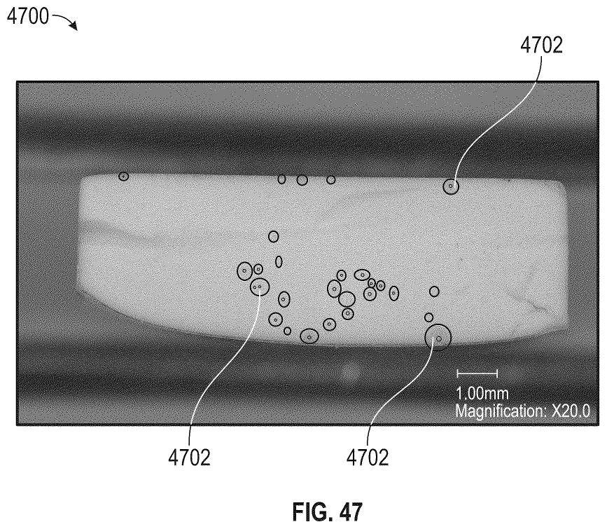

It was found that the PX printed specimen featured a higher density value than the PX cast specimen. This is mainly attributed to the PX printed specimen having residual pentaerythritol whereas the PX cast specimen 4700 featured voids 4702. Voids 4702 are marked with circles in FIG. 47.

Voids 4702 developed in the PX cast specimens 4700 more than in the PX printed specimens because the PX cast specimens 4700 exotherm extensively as they were mixed all at once, and the resulting condensation evaporated. A comparison of each cross section is shown in FIG. 47 taken by the Keyence VHX-7000. The cross section of the PX cast specimen features visible voids 4702 whereas the PX printed specimen does not feature voids but possessed some pentaerythritol on the surface.

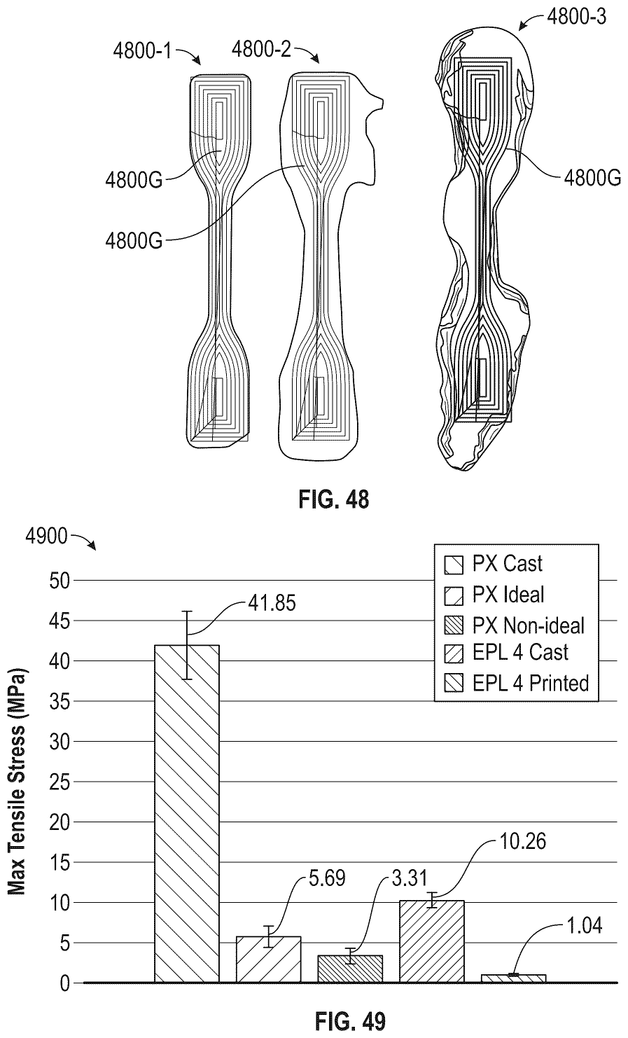

Tensile. Tensile testing was completed for cast specimens 4700 and printed versions 4800-1, 4800-2, 4800-3 of the EPL 4 as well as cast, an ideal, and non-ideal version of the PX, all at a crosshead rate of five millimeters per minute (5 mm/min). The intent of testing both an ideal version and a non-ideal version of the PX was to illustrate the impact of print resolution in terms of mechanical properties. Varying layer heights was used to create the ideal and non-ideal specimens, with non-ideal specimens featuring 2.5 mm height differences after each layer which resulted in excess flow and reduced the print resolution. To achieve a better understanding of what the original G-code path 4800G looked like, FIG. 48 depicts the print specimens 4800-1, 4800-2, 4800-3 with the G-code path 4800G laid on top of the resulting print specimens. The maximum width of the G-code print path 4800G is 18 mm at the width of the tab section and features 2 mm spacing between passes in the whole specimen 4800-1, 4800-2, 4800-3.

The tensile stress confirmed the hypothesis that a lower print resolution contributes to lower mechanical properties. The cross section of non-uniform gauge sections were measured in the smallest area with a caliper and averaged to calculate the tensile stress. The smallest area was assumed to have the highest stress concentration and in turn a higher probability of failing. FIG. 49 depicts the maximum tensile stress 4900 of each type of resin system.

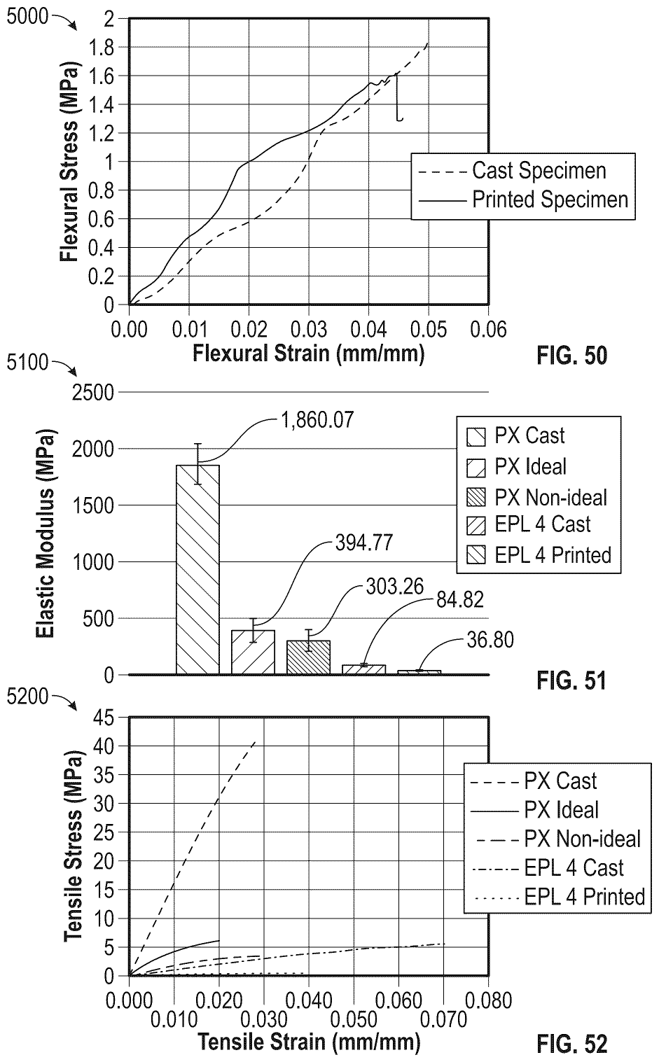

The EPL 4 cast specimens exhibited the highest strain before failing. In the representative tensile stress versus strain curve 5000 in FIG. 50, the EPL 4 cast specimen was required to be stopped early. The representative EPL 4 cast specimen elongated to 149% tensile strain and 10 MPa tensile stress.

The PX ideal specimens featured an 86.40% reduction in maximum tensile stress from the PX cast specimens. Whereas the PX non-ideal specimens featured a 92.09% reduction in maximum tensile stress from the PX cast specimens. The EPL 4 printed specimens showed an 89.86% reduction of maximum tensile stress from the EPL 4 cast specimens. Results for the PX non-ideal specimens have been lower than the PX ideal specimens and a similar trend is shown in FIG. 51 which depicts the elastic modulus values 5100 of each resin system.

The PX ideal specimens exhibited a 78.78% decrease from the PX cast specimens, but the PX non-ideal specimens showed an 83.70% decrease, which reaffirmed the hypothesis. The EPL 4 printed specimens featured a 56.61% reduction in elastic modulus from the EPL 4 cast specimens. Table 3 depicts a side-by-side comparison of each resin system and the included percent difference for maximum tensile stress and elastic modulus.

TABLE 3
Tensile test results of each resin system.

| | | % | Elastic | % |
|---|---|---|---|---|
| | Stress | Differ- | Modulus | Differ- |
| Tensile | (MPa) | ence | (MPa) | ence |
| PX Cast | 41.85 ± 4.18 | NA | 1860.07 ± 181.22 | NA |
| PX Ideal | 5.69 ± 1.25 | −86.4 | 394.77 ± 107.89 | −78.78 |
| PX Non-ideal | 3.31 ± 0.47 | −92.09 | 303.26 ± 96.84 | −83.70 |
| EPL 4 Cast | 10.26 ± 0.87 | NA | 84.82 ± 4.67 | NA |
| EPL 4 Printed | 1.04 ± 0.08 | −89.86 | 36.8 ± 2.20 | −56.61 |

Given that the PX specimens were more rigid than the EPL 4 specimens, it was expected that the PX specimens would have a lower strain to failure than the EPL 4 specimens. This hypothesis was confirmed during tensile testing as the average strain to failure for the PX cast specimens was 2.50% but the average strain to failure of the EPL 4 cast specimens was 195.97%. Table 4 provides the strain to failure results as well as the percent difference of each resin system. The PX non-ideal specimens featured a 27% drop in strain to failure which was expected as the PX non-ideal specimens featured stress concentrations.

TABLE 4
Strain to failure.

| | Strain to | % |
|---|---|---|
| Strain to Failure | Fail (%) | Difference |
| PX Cast | 2.50 ± 0.34 | NA |
| PX Ideal | 2.11 ± 0.42 | −15.6 |
| PX Non-ideal | 1.81 ± 0.56 | −27.6 |
| EPL 4 Cast | 195.97 ± 28.74 | NA |
| EPL 4 Printed | 5.44 ± 0.12 | −97.22 |

Flexural. 3-point bend flexural testing was completed on both the cast and printed versions of the EPL 4 and the PX. Using Equation 5.2 the crosshead rates for each resin system were determined, EPL 4 cast and printed specimens featured a crosshead rate of 3 mm/min, PX cast specimens utilized a crosshead rate of 1.54 mm/min, and the printed PX specimens featured a crosshead rate of 1.06 mm/min. The maximum flexural stress was taken at 2.64% strain, or failure, as the PX cast specimens failed on average at 2.64% strain. The end of test strain value deviated from the standard to provide better a comparison in the study. FIG. 52 features a representative stress versus strain curve 5200 of the EPL 4 flexural tests.

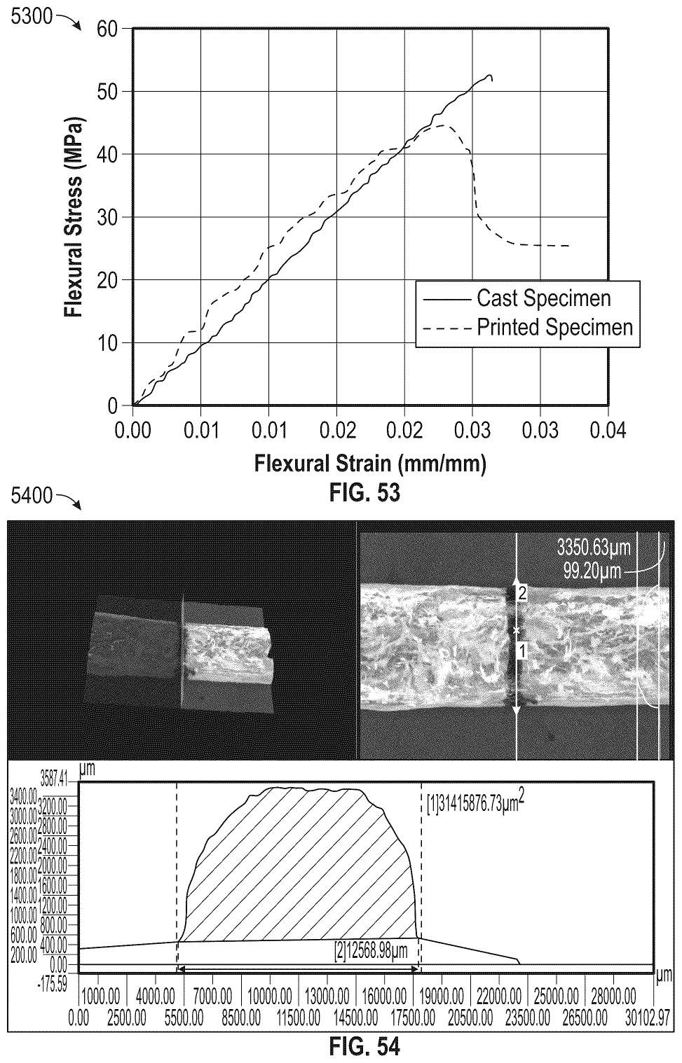

The lack of linear portions on the curve result from the low load exhibited on the specimen and the use of the 2 kN load cell. The average load required to deflect the cast specimens to 5% strain was 3.98 N. The average load required to deflect the printed specimen to 5% strain was 4.56 N. FIG. 53 depicts the stress versus strain curve 5300 of a cast and printed PX specimen.

The cast specimen featured linear deformation until failure whereas the printed specimen featured a semi-linear curve that failed before the cast specimen. The average force required for the cast specimens to fail was 86.20 N and the average force required for the printed specimens to fail was 22.57 N. The noise in each of the stress versus strain curve was a result of the low load on the 2 kN load cell as the 2 kN load cell has an accuracy of 0.5 N.

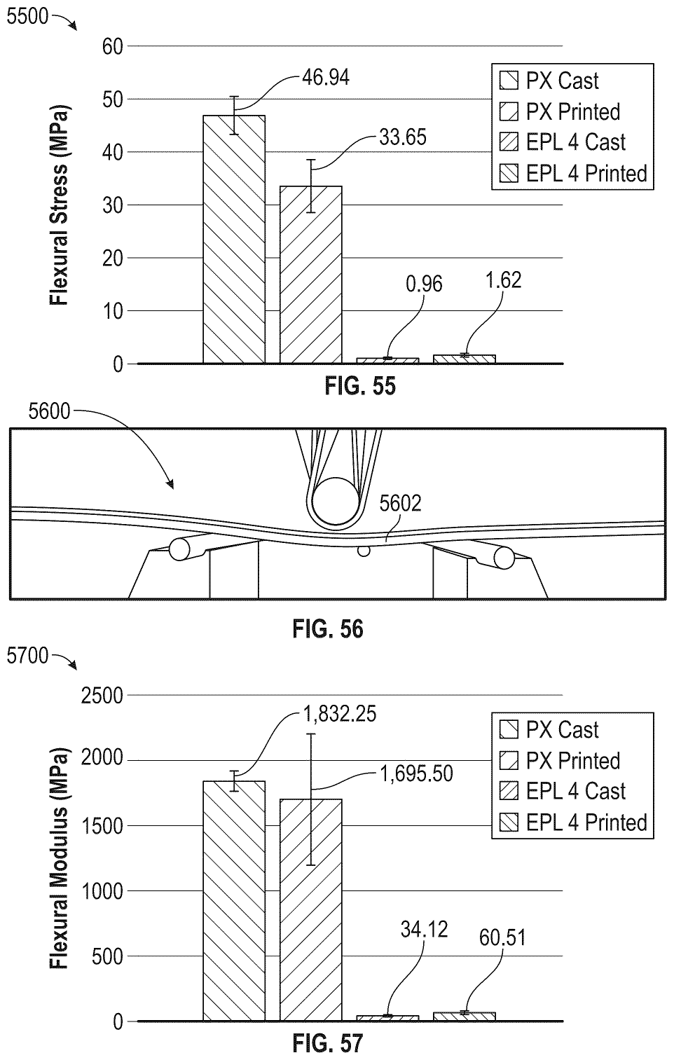

To accurately depict the cross-sectional area of the specimen, a VHS Keyence was used to capture 3D images. The PX printed specimens were partially translucent and partially opaque which results in an inaccurate cross-sectional measurement. To counteract this, a black line was drawn across the specimen which allowed for Keyence to capture an accurate image. Additionally, the Keyence lighting was changed to black and white. FIG. 54 below shows the captured image 5400 from the Keyence. FIG. 55 below depicts a bar graph showing the maximum flexural stress 5500 to 2.64% strain including standard deviation bars.

The increase in properties with the PX resin system was first expected after printing and before testing because the specimens were dry to the touch 2 min after printing and attained a high enough modulus to support itself after it was removed from the bed. In comparison to the EPL 4 which showed signs of excess polyol that remained after printing and was not mixed homogenously. The PX printed specimens exhibited a decrease in flexural strength by 28.31% compared to the PX cast specimens. The EPL 4 printed specimens show an increase of 72.34% of flexural stress at 2.64% strain compared to the EPL 4 cast specimens. This increase was because the EPL 4 cast specimens achieved a higher stress at 5% strain, but all specimens' values were recorded at 2.64% strain. However, the PX printed specimens were not optimally cured, and it was assumed the cast PX specimens were. Additionally, FIG. 56 depicts a photo 5600 of a PX printed specimen after deformation from flexural testing 5602. As shown in FIG. 56 some excess acetoacetylated pentaerythritol was shown on the tension side of a flexural specimen. It was confirmed to be acetoacetylated pentaerythritol because after 72 h the resulting bead did not react with moisture in the air nor change state. Unreacted m-xylylenediamine was observed to harden and form a white powder within twenty four hours (24 h) when exposed to room temperature and moisture. FIG. 57 shows the flexural modulus results 5700 from each resin system with standard deviation bars.

The flexural modulus of each specimen was taken from 0.01% strain to 1% strain. The flexural modulus of PX printed specimens were 28.31% lower than the PX cast specimen's flexural modulus. EPL 4 printed specimens featured a 77.34% increase in modulus compared to the EPL 4 cast specimens. The increase in properties was because of unreacted isocyanate curing and creating a material with a high modulus. Table 5 below depicts the average flexural stress at 2.64% strain for each specimen and the flexural modulus for each specimen.

TABLE 5
3-point bend results of each resin system.

| | Stress | | Flexural | |
|---|---|---|---|---|
| | at 2.64% | % | Modulus | % |
| 3-Point Bend | (MPa) | Difference | (MPa) | Difference |
| PX Cast | 46.94 ± 3.56 | NA | 1832.25 ± 154.25 | NA |
| PX Printed | 33.65 ± 8.76 | −28.31 | 1695.50 ± 502.10 | −7.46 |
| EPL 4 Cast | 0.94 ± 0.13 | NA | 34.12 ± 4.29 | NA |
| EPL 4 Printed | 1.62 ± 0.20 | 72.34 | 60.51 ± 6.53 | 77.34 |

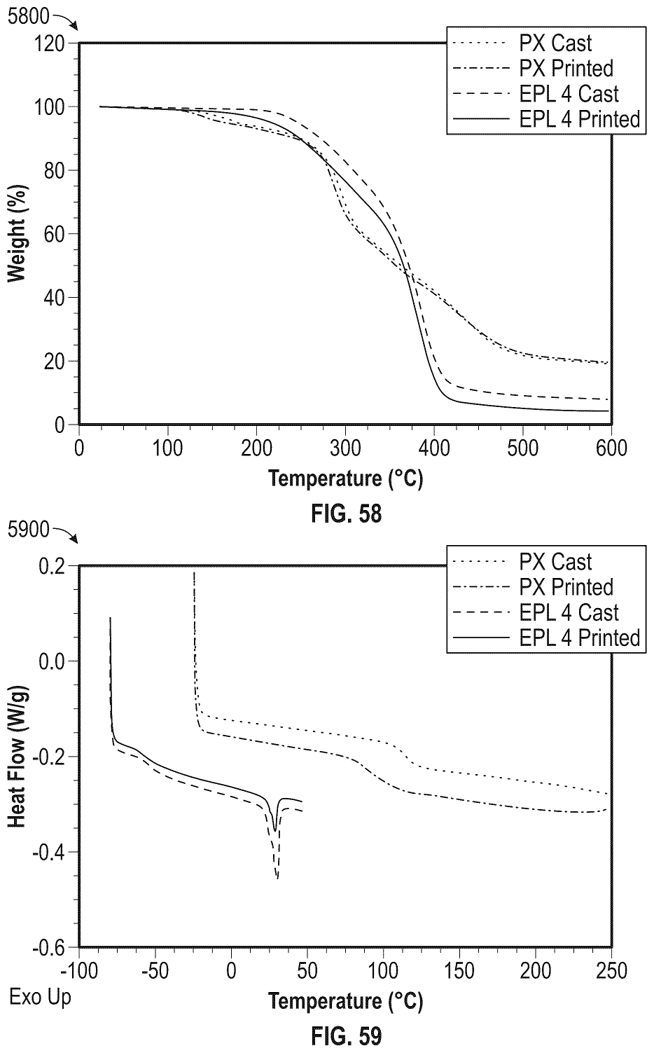

Thermogravimetric Analysis. Thermogravimetric analysis of cast and printed EPL 4 and PX specimens was completed and compared. Three specimens of each type were tested, all three sections came from the same specimen but different locations on the specimen, and the parameters were temperature ramp of 10° C. per minute, starting at 20° C. and finishing at 600° C. The printed specimen sizes ranged from 13.52 mg to 45.35 mg. The two materials have vastly different properties as shown in the tensile and flexural testing sections. It was expected that the printed specimens would have a lower degradation temperature as the printed specimens were not fully cured and would then start to degrade sooner due to having less cross-linking within the polymer chains. A representative TGA graph 5800 is exhibited in FIG. 58.

Table 6 depicts the degradation temperature for each of the specimens. The EPL 4 printed specimens degraded from 125° C. to 175° C. and the EPL 4 cast specimens showed initial degradation from 175° C. to 200° C. The PX printed specimens showed initial mass loss 85° C. to 100° C. and the cast specimens showed an initial mass loss from 100° C. to 115° C. The initial mass loss at lower temperatures indicated the vaporization of unmixed reactive resin in both systems.

TABLE 6
Degradation temperature of EPL 4 and PX specimens.

| | EPL 4 | % | PX | % |
|---|---|---|---|---|
| Specimen Type | (° C.) | Difference | (° C.) | Difference |
| Cast | 324.64 ± 3.64 | NA | 261.24 ± 1.15 | NA |
| Printed | 321.21 ± 1.46 | −1.06 | 256.29 ± 1.35 | −1.89 |

Differential Scanning Calorimetry. The glass transition temperature is the temperature where a polymer changes from a glass state to a rubber state. Given that the EPL 4 is an elastomeric material, rubbery at room temperature, it was expected to have a glass transition temperature below 0° C. The PX specimens were rigid at room temperature and were expected to have a glass transition temperature above 20° C. Each printed specimen was expected to have a lower glass transition temperature and it was proved in the results. Below in FIG. 59 is a representative DSC graph 5900.

The reason printed specimens exhibited a lower glass transition temperature was because the printed specimens received a lower quality mix than their respective cast specimens. With a lower quality mix the polymer chains are not fully cross-linked and require a lower temperature to bring the polymer chains out of the free state. Table 7 depicts the glass transition temperature values for both the cast and printed versions of EPL 4 and PX.

TABLE 7
Glass transition temperature of EPL 4 and PX specimens.

| | EPL 4 | % | PX | % |
|---|---|---|---|---|
| Specimen Type | (° C.) | Difference | (° C.) | Difference |
| Cast | −54.96 ± 0.56 | NA | 115.57 ± 1.58 | NA |
| Printed | −57.69 ± 1.05 | −4.96 | 91.38 ± 1.83 | −20.93 |

### Conclusion(s)

The PX specimens achieved higher mechanical properties than the EPL 4 specimens. Given that the PX specimens were tailored to be printed and the EPL 4 resin was a commercial resin intended for hand mixing, the PX resin system showcased more ideal process parameters. Given that the materials are two very different types, EPL 4 was more elastomeric than the PX, comparisons were drawn from cast specimens versus printed specimens of the same resin system.

The printed specimens featured a drop in properties aside from the EPL 4 flexural specimens which was because the stress values were taken at 2.64% strain instead of 5%. The EPL 4 printed specimens also featured an increase in flexural modulus by 77.34% over the EPL 4 cast specimen because of the unlinked isocyanate. The PX printed specimens featured a 28.31% decrease in flexural stress from the PX cast specimens but only a 7.46% loss in flexural modulus.

PX specimens were printed with varying print resolutions to test the effect of print resolution on mechanical properties. With low print resolution specimens obtained significantly more stress concentration points that lead to early failure. The PX non-ideal specimens featured a decrease 27.6% in maximum tensile strength compared to the PX cast specimens where the PX ideal specimens only featured a 15.6% decrease in maximum tensile strength. The PX printed specimens showed less of a decrease in mechanical properties than the EPL 4 printed specimens. It is concluded that the PX resin system is a superior resin system for the objectives because of the increase in mechanical properties combined with ideal process parameters. Reactive extrusion additive manufacturing is an emerging industry and will have many applications in the future.

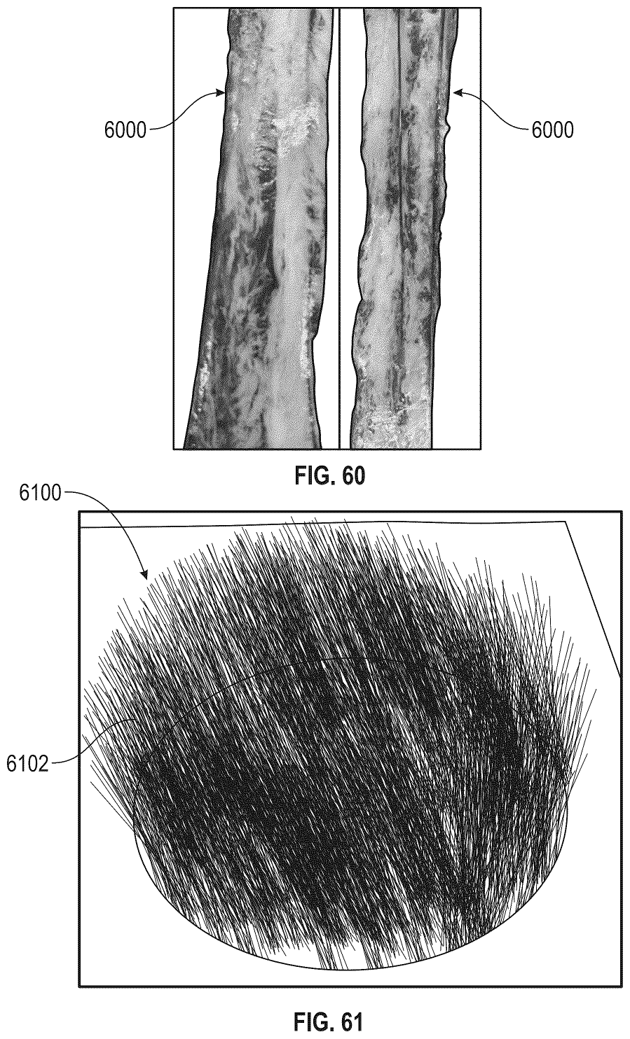

It is to be appreciated other two-part reactive resin systems can be used with the printer developed. Additional resin system utilization can show the versatility of the printer. Continuous carbon fiber introduction was completed. A change in resin system from the PX resin system allows the fiber to stay in place and help optimize print parameters. FIG. 60 shows a continuous carbon fiber print 6000 that is preferred.

To help keep the carbon fiber in place, a z-reinforced bed 6100 could be utilized. In addition to holding carbon fiber in place, the z-reinforced bed 6100 can also be composed of natural fibers 6102 to create a hybrid composite. Additionally, the z-reinforcement can act as support structure and would eliminate the need to print support structure in the future. Printing with the PX resin as well as printing with the continuous carbon fiber into the Z-reinforced bed 6100 has been completed. FIG. 61 depicts a photo of a z-reinforced bed which is composed of natural fibers 6102 (e.g., ixtle fibers sold under the tradename Tampico) and the base made of EPL 4 resin.

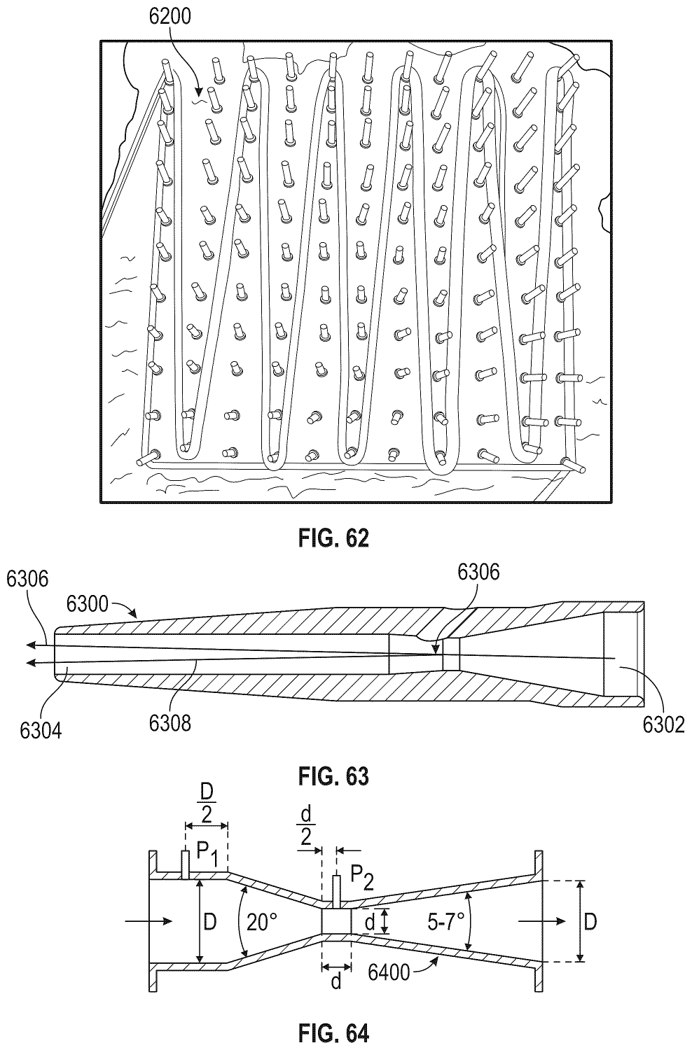

With uniform z-fiber spacing, it can be possible to change fiber layup direction each layer. FIG. 62 depicts a z-reinforced uniformly spaced bed 6200 with carbon fiber. To change fiber layup direction the print head can weave around the z fibers and result in a 45° and 90° fiber orientation.

Introduction of a continuous fiber to a liquid reaction resin system proved to be difficult initially. To introduce a continuous fiber, the area near the nozzle entry 6302 must be low pressure so that the resin does not flow through the fiber inlet hole, instead allowing only for reinforcement to flow along reinforcement flow line 6306 and a mixed resin flow 6308 to flow through nozzle exit 6304. FIG. 63 thus depicts the proposed solution: a venturi nozzle 6300 (which can also be referred to as a liquid injection nozzle) capable of introducing fiber in a low-pressure environment.

The venturi effect is the phenomena that results when pressure decreases and velocity increases. This effect can be observed when a fluid flow is constricted through a section of pipe. A schematic of the required dimensions of a pipe 6400 to undergo the venturi effect is depicted below in FIG. 64. This diagram was used to calculate the dimensions needed to create a low-pressure environment to introduce the fiber. A prototype was created using Solidworks 2018 (Waltham, Massachusetts) and was created with the Form 2 with 25 μm print resolution.

The next step is to refine the print parameters to decrease the excess resin. The excess resin exhibited in FIG. 62 is the result of decreasing the feed rate and maintaining the flow rate. After print parameter refinement, mechanical testing and large-scale printing can be completed. To showcase the effect of z reinforcement, compression testing can be completed.

Reactive Extrusion Additive Manufacturing with Continuous Fiber Reinforcement

Reactive thermoset resins are an expanding subset of additive manufacturing with many hurdles to incorporate fiber reinforcement. Reactive resins are defined as a mixture of two or more constituent parts that create a chemical reaction. Reactive resins are thermoset materials, meaning once they are cured, they are unable to be remelted and reused. Curing agents determine the mode and control the curing process of the resin. Three main classifications of reactive resin materials commonly used in industry are epoxies, polyesters, and polyurethanes.

Epoxy reactive resins are formulated by crosslinking an oligomer with at least two epoxide groups and curing agent. The properties of the epoxy resin are determined by the type of epoxy and curing agents used, as well as the degree of crosslinking between the two. For example, highly cross-linked epoxy resins are very brittle. In order to increase the toughness of the resin, a chemical toughening additive, or a reinforcing fiber like basalt, carbon, or glass are added. Fiber reinforced epoxy matrix composites (FRE) have become very popular in the automotive and aerospace industries due to the weight savings and high performance they provide. FRE has also made its way into the sporting goods industry in the form of golf shafts and tennis rackets.

Polyester resin materials cover a wide range of polymeric materials. Neat polyester materials tend to be very brittle and need the use of fiber reinforcement to ensure sufficient mechanical properties for industrial applications. One common reinforcing technique is chop-strand. This technique utilizes chopped fiber mats that are impregnated with polyester resin. One example of this is when chopped fiber glass is impregnated with resin to create what is commonly known as fiber glass. This is used to create boat hulls, bathtubs, and automotive parts.

The synthesis of polyurethane resins consists of a reaction between two monomers, typically being a polyol and isocyanate. The chemical reaction can result in a very fast gel time depending on the formulation, making it essential to have an accurate mixing ratio and dispensing speed. Polyurethanes tend to have very good surface adhesion making them desirable as an adhesive or coating. For example, polyurethane coatings are used on boat hulls to prevent corrosion and abrasion. Polyurethanes can also be used as a wide variety of foams. This includes being utilized as insulation or even cushions.

Reactive Extrusion Additive Manufacturing. Reactive extrusion additive manufacturing (REAM) is an additive manufacturing technique that is able to produce parts with high performance at faster build rates than other processes. REAM utilizes a multi part resin system to create a rapidly cured part. This rapid curing process is referred to as in-situ curing, meaning the resin will cure in an ambient environment without the need of external energy. REAM utilizes the mixing process to output a viscous resin material that holds its shape, allowing for more precise printing at higher deposition rates. Although the resin material is viscous enough to hold its shape, the resin is not fully cured, allowing for chemical crosslinking between layers as they are added to the part. This increases the interlayer strength of the part and greatly reduces the possibility of interlaminar failure compared to other additive manufacturing techniques. As subsequent layers are added to the part, the lower layers continue to cure to create a base rigid enough to support the continuation of added layers.

Along with the faster build times, REAM is able to produce parts with better mechanical properties compared to other additive manufacturing techniques. The use of thermoset materials in REAM compared to thermoplastics used in other additive manufacturing processes like FDM is just one reason for the ability to produce higher performing materials. The crosslinking between layers in the REAM process allows for near isotropic mechanical properties. Researchers at the University of Texas supported this claim and found that REAM parts had higher tensile strength and stiffness compared to ABS, PLA and Nylon parts produced by fused filament fabrication. Furthermore, researchers at PPG found that their REAM produced parts had an increased shear modulus and eliminated internal stresses and bulk distortions compared to parts produced by other additive manufacturing techniques.

Unreinforced polymeric materials lack the strength and stiffness needed for many high-performance applications. To further improve the mechanical properties of polymeric materials, reinforcing fibers are introduced to create a composite material. This allows for a high strength and stiffness material, while still being lightweight. The way in which the fiber can be introduced can come in a variety of ways, including a fiber mesh, short fibers, and continuous long fiber.

Common continuous long fibers that are used for reinforcement are glass, basalt and carbon. Glass fibers are very commonly used in structural composites. Glass fibers exhibit great mechanical properties, and those properties can be varied for specific applications with different compositions. Glass fibers, which are derived from silica, can be classified into three different types: E glass, C glass and S glass. E glass is considered to be a good electrical insulator, whereas C glass has a high chemical corrosion resistance. S glass, which has a higher silica content than E and C glass, is used in high performance composites that need to withstand higher temperatures. E and S glass are the two most common types of glass fibers used in structural composites. To go along with the different compositions, glass fibers exhibit a very low density and very high strength at a lower cost. This makes glass fiber attractive for a wide variety of applications such as boat hulls, window frames, piping and the aerospace and sporting goods industries.

Basalt fibers are formed from the melting of basalt rocks. This makes basalt one of the most sustainable reinforcing fibers due to the abundancy of raw materials, and the production process being very environmentally friendly. The production process also makes the cost of basalt fibers reasonable as no additives are added in a single production process. Beyond the sustainability and low cost of production, basalt fibers exhibit good mechanical properties. These include high temperature and chemical resistance, as well as a higher tensile strength than E glass and a larger failure strain than carbon fibers. Basalt fibers also have a strong affinity to bond with other materials. Basalt fibers are commonly used in reinforcement of concrete but have also been used in many other applications, including acoustic and thermal insulations, electromagnetic shielding, automotive and even household appliances.

Carbon-based fibers are derived from a precursor fiber that goes through a carbonization and graphitization process. The most commonly used precursor used today is polyacrylonitrile or PAN. The result is a lightweight, high modulus and high strength material known as carbon fiber. Like glass fibers, carbon fibers can be produced to exhibit a wide variety of mechanical properties specific to the application in which they are being used. With the desirable mechanical properties at a reasonable cost, carbon fibers have been implemented in a wide range of industries. These include polymer matrix composites in the aerospace, aircraft, automotive and sporting goods industry.

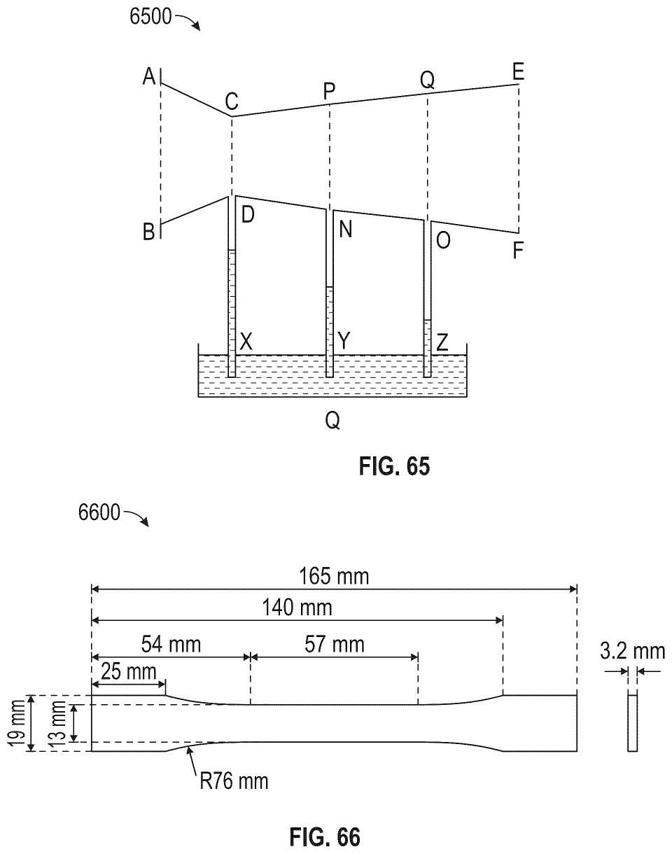

A common way to introduce a foreign substance into a fluid medium is utilizing the venturi effect. The venturi effect follows the Bernoulli Principal for smooth, steady state laminar flow. Applying the Bernoulli equation to the case of a venturi, the following equation can be derived to better explain the venturi effect:

$$\frac{1}{2} ρ {v}^{2} + p = constant$$

wherein fluid density is denoted by ρ, fluid velocity by ν, and fluid pressure by p. The sum of the aforementioned equation is constant through the medium in which the fluid is flowing, thus creating a relationship between the fluid velocity and pressure. As the area of the medium decreases, the fluid pressure decreases and subsequently the fluid velocity increases. FIG. 65 illustrates this. In the case of a venturi system 6500, it becomes possible to introduce a foreign substance into a flow medium at the point after the low-pressure high velocity ends and the high-pressure low velocity begins.

For the case of REAM, a venturi nozzle will be used in order to introduce the continuous fiber into the mixed two-part resin system. This will be accomplished by introducing the fiber at the point of low pressure, allowing for the fiber to integrate into the resin system without the loss of resin material leaving the nozzle prior to the exit orifice.

### Testing

Tensile. For tensile testing, the ASTM D638-14 testing standard was followed, the standard being hereby incorporated by reference in its entirety herein. An MTS Criterion Model 43 load frame equipped with a 2.5 kN or 30 kN load cell and a 25.4 mm extensometer will be used to carry out the tensile test. The load frame will be set to have a five millimeter per minute (5 mm/min) crosshead rate. Following the ASTM standard, a minimum of 5 neat resin and 5 fiber reinforced test specimens 800, 6600 will be made for each resin and fiber combination. The neat resin test specimens dimensions will be type IV as called out in the ASTM standard. The fiber reinforced test specimens dimensions will be type I for reinforced composites. The dimensions for both type IV and type I are in FIG. 8 and FIG. 66, as called out for in the ASTM standard. Tensile testing will result in determining the Young's Modulus, yield and ultimate tensile stress and strain at failure for each resin and fiber combination for comparison.

Flexural. Flexural testing will be conducted on an MTS Criterion Model 43 load frame with a 2.5 kN load cell. According to ASTM D790-17, which will be followed for the flexural testing, a three-point bending test will be applied to the test specimens until the specimen reaches 5.0% strain. At least 5 neat resin and 5 fiber reinforced test specimens will be used for each resin and fiber combination. Each test specimen will have a 16:1 span length to thickness ratio in accordance with the ASTM standard. Once the samples are produced, the crosshead rate of the MTS can be calculated using the following equation.

$$R = \frac{{ZL}^{2}}{6 d}$$

where L is the support span in mm, d is the depth or thickness of the specimen in mm and Z is the rate of straining of the outer fiber which will be set to 0.01 mm/min.

Thermogravimetric Analysis. To determine the thermal degradation temperature of the two different resin systems, thermogravimetric analysis (TGA) will be performed in accordance with ASTM D3850-19, which is hereby incorporated by reference in its entirety herein. TGA testing will be performed on a Discovery TGA550 machine.

Dynamic Mechanical Analysis. Dynamic mechanical analysis (DMA) of each resin-fiber combination will be carried out in a dual cantilever beam following ASTM D5418-23, which is hereby incorporated by reference in its entirety herein. DMA will provide the viscoelastic properties of the test specimens. This includes the glass transition temperature and the loss and storage modulus. The test apparatus that will be used for the DMA testing is a Discovery DMA550.

Differential Scanning Calorimetry. In accordance with ASTM E2160-04, differential scanning calorimetry (DSC) will be performed on each resin-fiber combination. DSC is conducted to determine the degree of curing in the two-part resin system. The DSC of the samples will be performed on a Discovery DSC Q2000 machine.

### Sample Manufacturing Technique

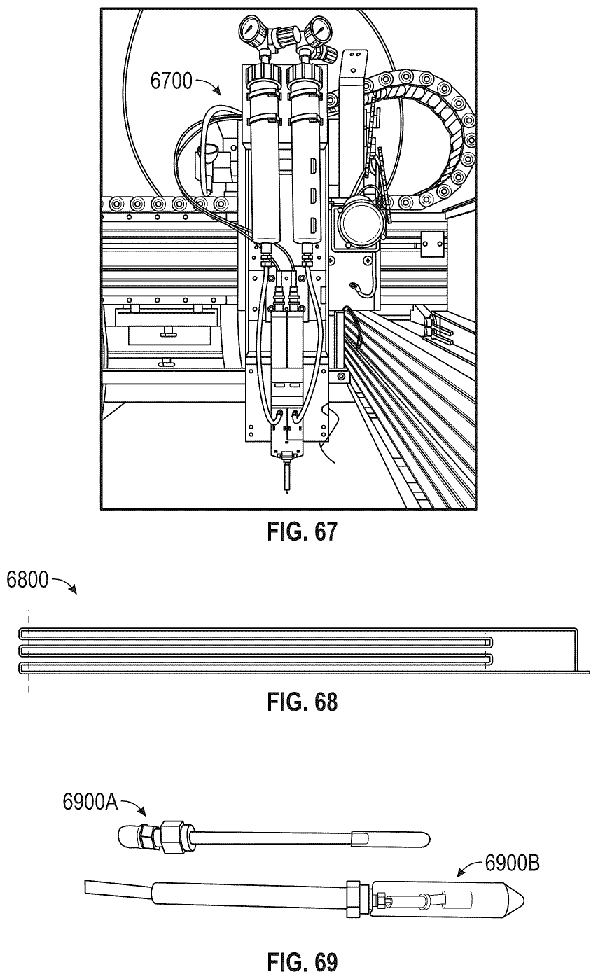

For the mixing and dispensing of the two-part resin system, a Viscotec Vipro-HEAD 5/5 can be used. The print set-up 6700 of FIG. 67 accurately dispenses the two resins at a 1:1 volume ratio into the static mixer attached to the bottom as seen in FIG. 67. When incorporating fiber to the print, a venturi nozzle will be added to the end of the static mixer.

In order to manufacture test specimens, a straight-line test can be conducted for both neat resin and fiber reinforcement for each fiber and resin combination. This straight-line test can be used to determine the bead width of the print that will be used to generate the G-Code used for the print.

When preparing the samples, a neat resin will follow the G-Code pattern 6800 shown in FIG. 68 for multiple layers to form walls. These walls will act as a barrier to hold the fiber while taking turns. The walls will be spaced apart the same width of the bead that includes fiber. Upon completion of the neat resin print, the ends of the neat lines will be cut off at the dashed yellow lines in FIG. 5. This will be done in order for a fiber print to infill between the walls. This pattern will be repeated to create a large composite sheet. From there, the sample can be cut out of the sheet to the desired dimensions for testing.

Mixing and Dispensing. Where a SLA 3D printed static mixer was used inside an aluminum tube to combine the two-part resin system, it was found that due to the high viscosity of the resin system and the dimensional inaccuracy of the SLA printed mixers, the resin would slide down the walls of the tube and push out the static mixer. To combat this issue, an inline metal Stratos Static Tube Mixer was purchased from Koflo. The technical specifications of the stock static mixer can be seen in Table 8.

TABLE 8
Stock technical specifications of Koflo static mixer.

| | | | | Max | |
|---|---|---|---|---|---|
| | Tube | Tube | | Working | Number |
| Statos | O.D. | I.D. | Length | Pressure | of |
| Part No. | (mm) | (mm) | (mm) | (MPa) | Elements |
| 3/16-17 | 4.750 | 3.353 | 123.825 | 37.474 | 17 |

The static mixers were cut down from their stock length of 123.825 mm (4-⅞ in.) to a length of 90 mm (3-½ in.) to push the resin material through the mixer faster due to the fast gel times of the resin system. The two static mixing systems 6900 are shown in FIG. 69.

Further issues with mixing of the resin system arose from the way the two-part resin system was integrated into the static mixers. Two syringe drivers were used to push the resin material into the static mixer. Due to the high viscosity of the materials, the pressure built up in the syringes and caused the syringe driver motors to cam. This prevented a consistent 1:1 volume ratio of both parts of the resin system, resulting in an insufficient mix for proper curing.

### Venturi Nozzle Design

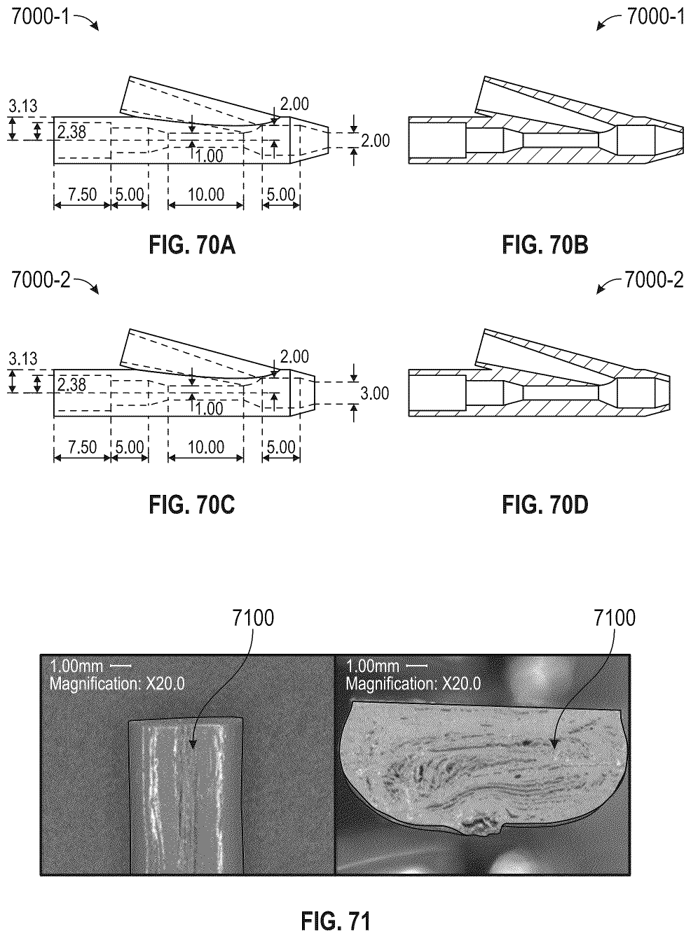

The venturi nozzle design was first used in the original static mixer system used by Patton, seen on the bottom of FIG. 69, to ensure that the fiber could effectively be introduced into the nozzle without any back flow. Once it was determined that the design was sufficient enough to prevent any resin backflow out of the fiber introduction hole, it was adapted for the inline static mixers from Koflo. Two different nozzle sizes with exit hole diameters of 2- and 3-mm respectively were then able to be produced with an SLA 3D printer. FIGS. 70A-70D show the cross-sectional view and the drawings with the key dimensions of the 2-mm nozzle 7000-1 and 3-mm nozzle 7000-2. These nozzles were used in conjunction with the Koflo inline static mixers for the preliminary testing.

### Results

To determine the printability of incorporating continuous long fibers into a REAM system, a single line print was conducted. In this print, resin system A was combined with carbon fiber. FIG. 71 shows that the carbon fiber 7100 floated on top of the resin bead during the print.

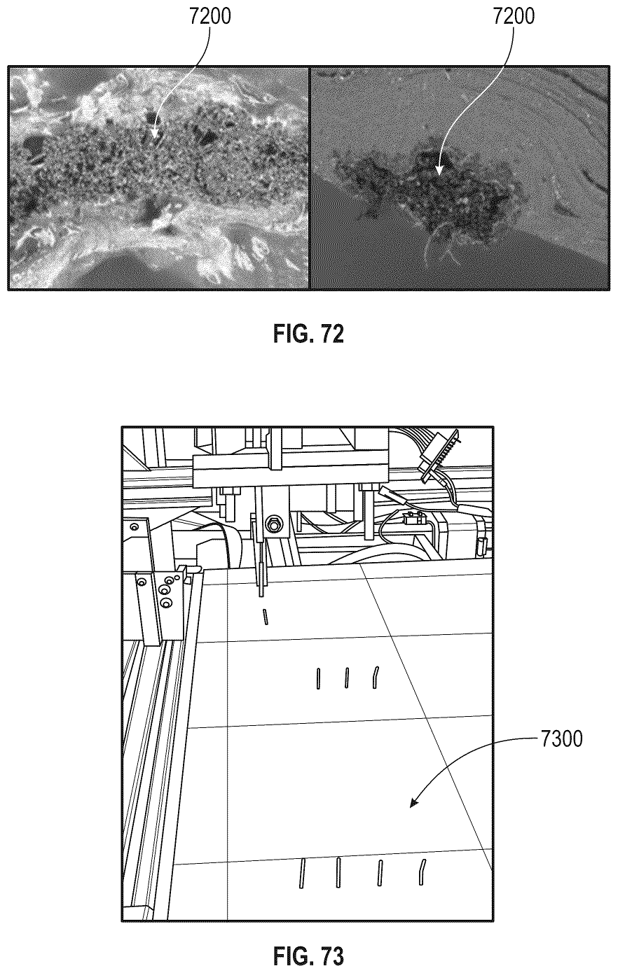

Due to the high viscosity of the resin system, the resin was unable to penetrate into the carbon fibers and wet out the individual filaments. Instead, the carbon fiber 7200 became encapsulated by the resin system which is better shown in FIG. 72.

During the straight-line print, it was found that it was not possible to take turns during the print without the fiber pulling out of the bead. Therefore, to create any sort of testing specimens, small nails were put into the print bed to create a grid to hold the fiber while taking turns.

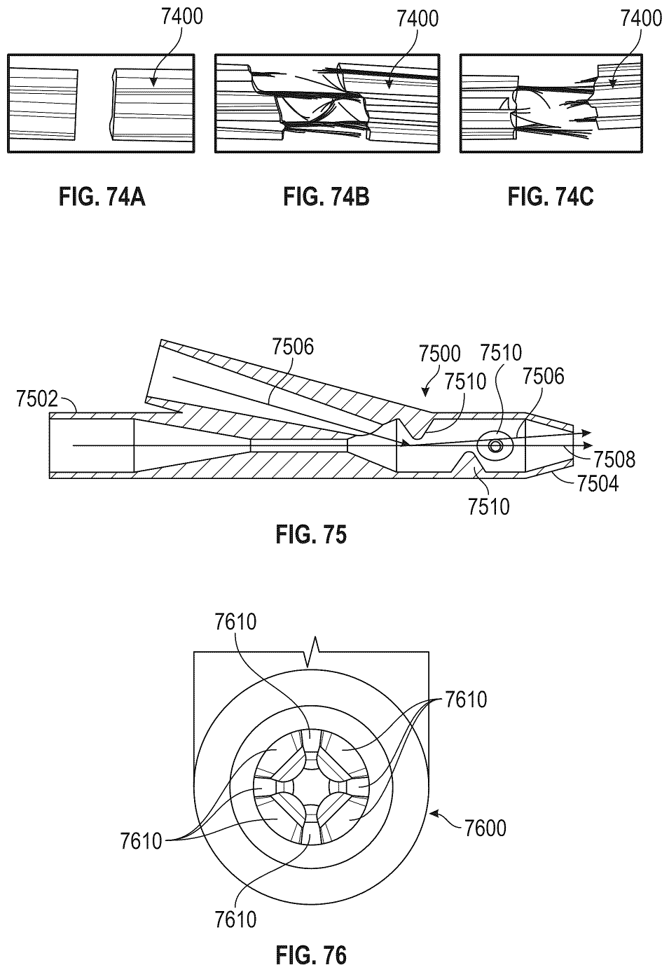

With the grid 7300 shown in FIG. 73, multilayer samples were produced utilizing resin system B and glass fiber. Three, two-layer samples were produced, one neat resin and two with the glass fiber reinforcement. Again, it was found that the resin system was unable to penetrate the fibers and the fiber floated on top during the print. The three samples were subjected to tensile testing to gain a baseline of the mechanical properties and the testing nature of the polymer and composites. The tensile test was conducted at a crosshead rate of 10 mm/min and no tabbed grips. In FIGS. 74A-74C, it can be seen that the composites 7400 experienced significant fiber pullout. This can be partially explained by the fiber floating on top during the print leading to poor wet out.

### Baseline Massage Nozzle Testing

In an effort to improve wetout, a massaging nozzle design was conceptualized. This nozzle had nodes running throughout the area just past the introduction of fiber. The intent of these nodes was to aid in moving the fiber and effectively massaging the resin into the tow and improve wetout. The massage nozzles acted in a way to move, separate, and promote resin and fiber interactions. Initial prints qualitatively indicated significant improvement. Originally, a four-node nozzle 7500 was designed and can be seen in FIG. 75.

In an effort to improve wetout, a massaging nozzle design was conceptualized. The design in similar to the venturi nozzle 6300, the area near the nozzle entry 7502 must be low pressure so that the resin does not flow through the fiber inlet hole, instead allowing only for reinforcement to flow along reinforcement flow line 7506 and a mixed resin flow 7508 to flow through nozzle exit 7504. This nozzle had nodes 7510 running throughout the area just past the introduction of fiber. The intent of these nodes was to aid in moving the fiber and effectively massaging the resin into the tow and improve wetout. The massage nozzles acted in a way to move, separate, and promote resin and fiber interactions. Initial prints qualitatively indicated significant improvement. Originally, a four-node nozzle was designed and can be seen in FIG. 75.

FIG. 76 shows an inline image of looking into the nozzle end 7600 at the massage nodes 7610. This iteration had eight nodes 7610. The nodes were offset so the cross-sectional area is not being constricted but with the walls effectively moving around to force fiber movement. The path in the center is smaller than the fiber tows being incorporated into the composite print.

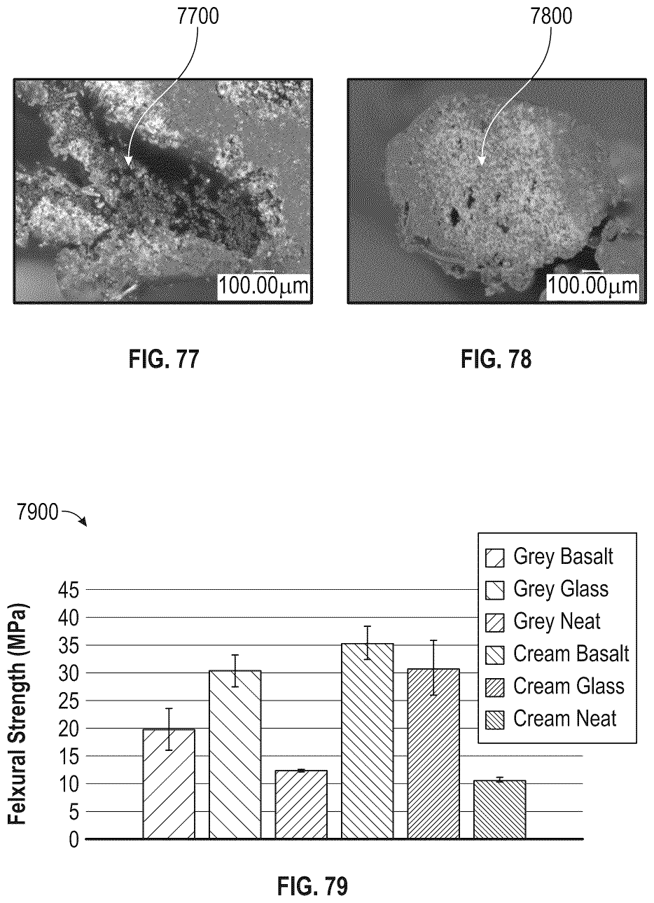

It was immediately evident that this nozzle modification improved the wetout of the prints. FIG. 77 shows another instance of the encapsulation of fiber tows 7700 with the venturi nozzle 6300. FIG. 78 shows the observable improvement 7800 with the massage nozzle 7500.

Baseline flexural and tensile testing was completed with the 2.5 mm/four node nozzle and much was learned. The testing was able to prove that it was possible to successfully test specimens without tabbing and get proper failure outside of the grip sections. The created samples were tested 14-to-21-days after the samples are manufactured. The 14-to-21-day window was used to ensure equal curing time for all specimens. The specimens demonstrate the ability to print with 2 different resins and 2 different fiber types and dramatically improve the performance of the printed properties.

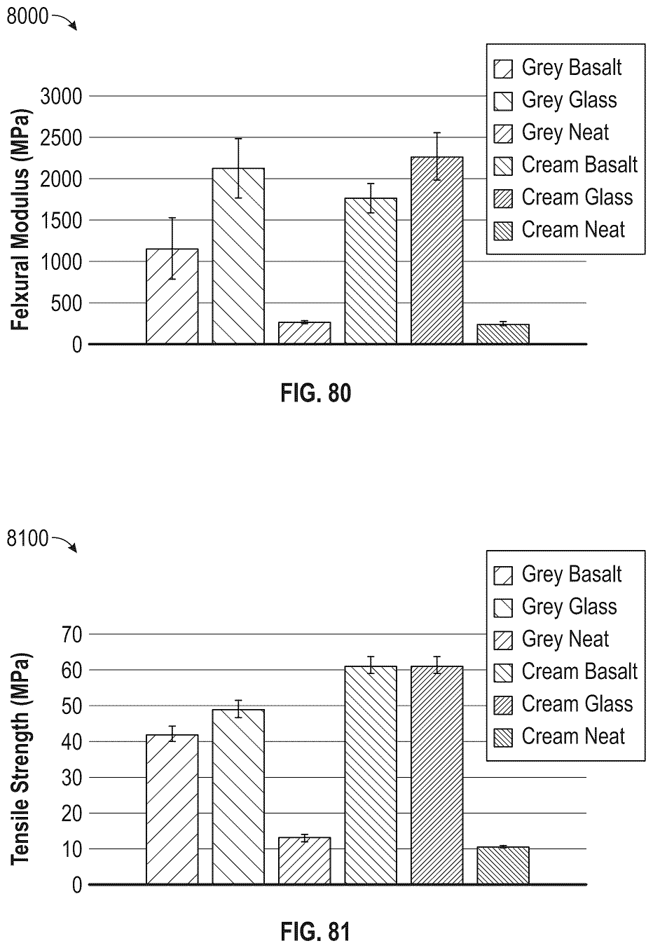

Flexural Results. The baseline flexural properties in FIG. 79 and FIG. 80 illustrate the property improvements 7900, 8000 of introducing basalt and fiberglass reinforcement into the printed specimens. The neat specimens do not have any reinforcement and are pure polymer. The cream resin systems showcase better improvement in properties for both glass and basalt fibers can be attributed to better wetout that occurred in the cream resin that has a longer gel time, allowing more time for resin to flow into the fiber tow.

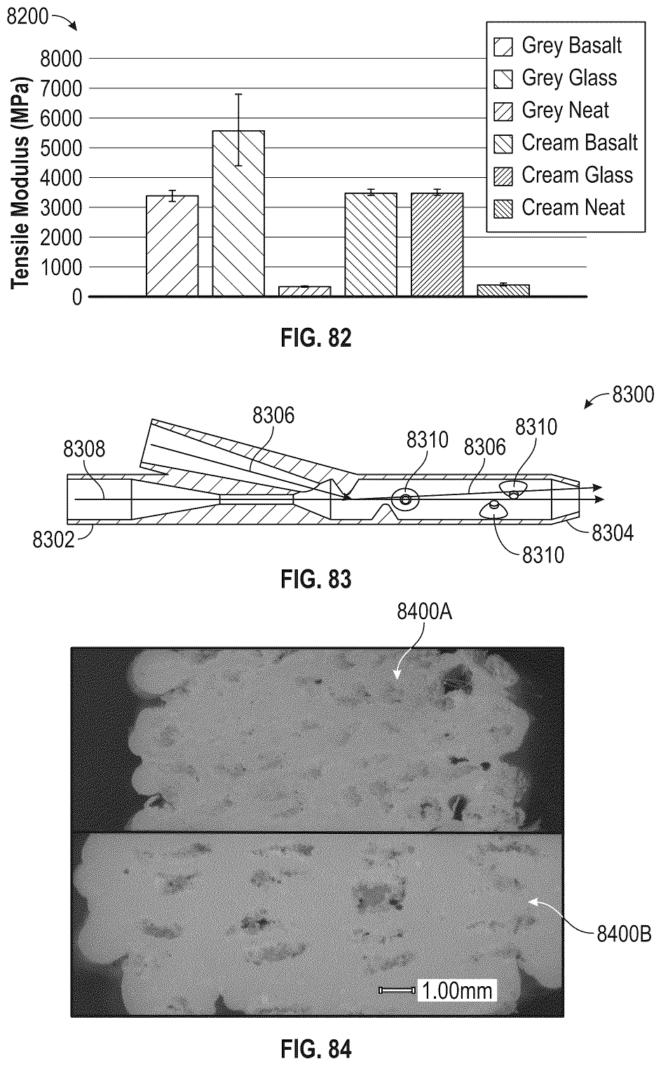

Tensile Results. The baseline tensile properties in FIG. 81 and FIG. 82 showcase the property improvements 8100, 8200 by introducing basalt and fiberglass into the specimens. These specimens are printed the same way the flexural specimens were printed and provide a great indication of the performance gains possible with fiber introduction. Wetout and fiber volume fraction were still the main issues plaguing the further property advancement.

Fiber volume fraction of the baseline specimens can be seen in Table 9 below. The results show that the fiber content for the glass was consistently higher, which is mostly attributed to the fiber tow is larger for the glass with the same nozzle sizes. However, the fiberglass might have double the fiber volume fraction but only slight gains in properties in some of the combinations.

TABLE 9
Fiber volume fraction of baseline specimens.

| | | Specimen Type | | | |
|---|---|---|---|---|---|
| | | Grey | Grey | Cream | Cream |
| | | Glass | Basalt | Glass | Basalt |
| Volume | Fiber | 8.389 ± 0.238 | 3.685 ± 0.100 | 7.189 ± 0.321 | 2.185 ± 0.200 |
| Fraction (%) | Matrix | 86.014 ± 1.860 | 92.992 ± 0.738 | 83.663 ± 0.819 | 84.571 ± 2.427 |
| | Void | 5.597 ± 2.082 | 3.323 ± 0.707 | 9.148 ± 0.718 | 13.243 ± 2.586 |

### Massage Nozzle

The concept of a nozzle design that creates a massaging and resin impregnation improvement of the fiber tow were trialed and expanding the study past the baseline four massagers. Nozzle diameters were altered to identify the effects of nozzle diameter and fiber volume fraction improvements. A second study involved the effects of massaging nodes. Different number of massaging nodes and the size of the nodes are isolated to see if the increase in fiber agitation improves performance. FIG. 83 illustrates a nozzle 8300 with added massaging nodes 8310. In an effort to improve wetout, a massaging nozzle design was conceptualized. The design in similar to the venturi nozzle 6300, the area near the nozzle entry 8302 must be low pressure so that the resin does not flow through the fiber inlet hole, instead allowing only for reinforcement to flow along reinforcement flow line 8306 and a mixed resin flow 8308 to flow through nozzle exit 8304. The present disclosure includes, at least, nozzle diameters of 1.5, 1.75, and 2 mm along with four and eight massaging nodes with two different amounts of interference.

FIG. 74 depicts a tensile specimen post testing of a cream fiberglass print with the venturi nozzle that allowed the introduction of the fiberglass into the resin flow. This was a great first step. FIG. 84 compares original and massage nozzle specimens. The venturi nozzle print 8400A is in the bottom picture. A print 8400B using the venturi nozzle with massagers and 1.5 mm exit diameter is in the top picture. It can be easily seen on the top specimen that each fiber tow is impregnated with resin and a much tighter fiber bundle with less voids. Both prints have the same fiberglass size and resin type but the fiber tow appears to much larger in the lower picture as the tow is not wetout completely and includes a center core full of voids. Here again, the massage nozzle greatly improved the fiber wetout and void reduction by getting the resin into the tow before exiting the nozzle.

From the foregoing, it can be seen that the present disclosure accomplishes at least all of the stated objectives.

### Research Methologies

### Thermoset Resin Additive Manufacturing

Polymeric Material. Two resins were comprehensively evaluated.

The first one is commercially available through Specialty Products, EPL™ 4 (Lakewood, Washington). EPL 4 is a self-leveling polyurea elastomer created to repair material cracks such as warehouse floors or decks. Table 10 depicts some of the advertised properties of EPL 4. The EPL 4 polyurea was selected because it was developed to be statically mixed or sprayed and possessed a curing profile that includes a 4-minute gel time, which is desired for dispensing. Initially, mechanical properties of commercial resins were not considered, pot life was the most important parameter considered. The EPL 4 features 100% solids and is not a condensation reaction. A 100% solid material was ideal because it allowed for the assumption that each layer deposited on top of one another produced a uniform cross section.

The second resin was developed by NDSU's Coatings and Polymers Department. The experimental resin was tailored for pot life, viscosity, and post cure procedures best suited for the systems developed. The resulting polymer system selected was a polyenamine system produced via a condensation reaction, which does not produce any volatile organic compounds.

TABLE 10
Specialty Products EPL 4 Properties.

| Tensile Strength | Elongation | Modulus | Pot Life |
|---|---|---|---|
| (Mpa) | (%) | (Mpa) | (min) |
| 16 | 245 | 6 | 4 |

Casting Neat Baselines. While the commercial resin, EPL 4, has published mechanical properties, the resin was cast to generate a set of baseline mechanical properties using the same test parameters in the present disclosure. The molds were cast Smooth-On Mold Star™ 15 Slow silicone that was poured over a stainless-steel die of exact geometry for tensile and flexural testing. To create a baseline of properties to compare printed samples against, an impeller mixer was used at a 1000 rpm for 30 s to create EPL 4 cast specimens. No degassing was possible for the EPL 4 as the system cured quickly and did not foam upon starting the exothermic reaction. Foaming could occur if the exothermic temperature reached high enough to vaporize the polyol resin. Each mold was filled by pouring the homogeneously mixed resin system from a beaker and then a weighted plate was placed on top of the molds to ensure each specimen was flat and resulted in a uniform cross section. Without having a weighted plate on top of the molds, the EPL 4's surface tension would create a rounded surface on the top. Additionally, the experimental resin created by NDSU's Coatings and Polymeric Materials Department was hand mixed for 15 s until the resin started to exotherm then it was poured into silicone molds. The system required a section of the material to be restrained for uniform flat parts but needed other area to be unrestricted and allowed to foam. The tensile specimens featured restriction in the gauge area and the grip section was free to foam. The flexural specimens were sanded down to flat sections removing the excess resin that created a curved structure as well as the grip sections of tensile specimens were sanded. Each resin system cured in the mold at room temperature for 24 h before being removed from the molds and continued to cure for at least a total of 72 h before testing. No post-curing was performed as the resin systems were designed to cure over a 72 h period at room temperature.

Printing. The specimens were printed directly to the specific geometry per each test ASTM standard. This was performed because the machineability of elastomers is very low and to prove that a part can be printed using this approach. It was expected that the 3D printed specimens would have lower layer adhesion and resolution than the cast specimens because the cast specimens would be deposited entirely at once and the printed specimens were deposited layer by layer. Another drop in properties was expected because low print resolution causes stress concentrations that would cause premature failure. For these reasons it was expected that the 3D printed specimens would have lower mechanical properties than the cast specimens. The specimens were oriented to print with the lowest overall height to allow the bed to support each print. The bed supported the resin and the resin flowed less than if it was being supported by a small section of the printed specimen.

Equipment Setup. The equipment used to create the custom mix chamber consisted of an aluminum pipe, two threaded brass barbed tube fittings, and a stainless-steel wye connector. The material selection was dictated by the need to burn off and clean the mix chamber components while structural integrity remained intact. PVC plastic tube was connected from the syringes to the barbed tube fittings. The sections of PVC plastic tube were of similar length to ensure each tube experienced similar expansion in the lines. Each barbed fitting threaded sections and each threaded end of the aluminum pipe were wrapped in Teflon to ensure a seal was made at each connection.

Printer. The printer used was an ADIMLab Gantry Pro 3D Printer (Shenzhen, China) and it was selected because of its bed size, and open-source software. The bed size of the printer was larger than other printers of comparable price, it features a 310 mm by 310 mm build plate, and it has a maximum height of 410 mm. To protect the print bed from any damages, an aluminum plate of the same size was used to print on. Additionally, the aluminum plate required masking tape be applied to it to allow for the easy removal of printed specimens. The printer's preferred software is Repetier-Host, Hot-World GmbH & Co. KG, Germany, which allowed for each print parameter to be adjusted as needed. It was necessary to control the feed rate as well as having the ability to turn off and remove the heated extruder nozzle while still being able to print. Repetier-Host also features a print preview that allows the G-code to be reviewed prior to printing to ensure the print path is correct as well as five manual control buttons that can be customized with 1000 lines of G-code.

CAD Modeling/Slicing/G-code Work. Directly printing test specimens requires the printer to have a resolution fine enough to accurately deposit samples. The ADIMLab gantry featured position accuracy up to 0.01 mm in X and Y plane and 0.04 mm in the Z direction. Given that the gantry positioning accuracy is far higher than what was needed, the nozzle, flowrate, and G-code needed to be tailored to improve print accuracy. To accomplish this, the CAD models of the specimens needed to account for the resin build up on any edges of the print. Resin build up at each turn on the print was a result of the printer's inability to maintain a constant speed. The print head velocity decreases when it turns which delivers an inconsistent amount of resin. Additionally, as the resin was deposited, the resin continued to flow and flatten out to a width larger than the nozzle outlet diameter. To account for this, G-Code was manually written for each test specimen. G-code is the language 3D printers and other manufacturing machines read. G-code is read as a coordinate system, specifically an X-Y-Z coordinate system, where the Z direction is the build thickness. To print flexural specimens, the X space between layers is written with a MATLAB code that allows for a Y length of 150 mm.

Qualitative Results. The selection process to provide feedback to the Department of Coatings and Polymeric Materials of the custom resin system used qualitative parameters; these included, speed of dispensed volume, gel time without a post cure, flow of extruded bead while adhering to desired print geometry, and the overall solidification of a finished print. First, the speed from inlet to outlet of the mix chamber was determined by doing a volumetric flow rate calculation and through experimentation. It was found that the time spent in the mix chamber effected the possibility of producing a print. This was because the resin systems used featured a very quick gel time and would gel inside the mix chamber if too much time was spent in the mix chamber. Additionally, each time the speed of the syringe driver was adjusted, the feed rate was also adjusted to maintain the ratio found.

Reactive Extrusion Additive Manufacturing with Continuous Fiber Reinforcement

Resin. Two, two-part reactive resin systems will be used for the comparison of mechanical properties and printability in the REAM system designed and built for this study. Each resin system is a proprietary blend thus they will be referred to as resin A and resin B. Resin A can be identified by its grey color and resin B by its cream color. Both resin systems are mixed at a 1:1 volume ratio.

Fiber. The two fiber types selected for comparison are basalt and glass. The basalt and glass fibers that will be analyzed are Sudaglass BCF-800-13-1 and Owens Corning Type 30 SE 1200. The basalt fiber has a tex value of 264 and the glass fiber has a tex value of 1100. The mechanical properties of the composite material and the fiber wet out will be the criteria that will be used for the comparison of the two fibers. The mechanical properties of both fibers can be seen in Table 11.

TABLE 11
Mechanical properties of basalt and glass fiber.

| | Density | Tensile | Elastic |
|---|---|---|---|
| | (g/cm\hat{ }3) | Strength (Mpa) | Modulus (Gpa) |
| Basalt | 2.75 | 4840 | 89 |
| Glass | 2.62 | 2600 | 82 |

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 12
List of Reference Characters.

| | |
|---|---|
| 100 | helical static mix rod |
| 200 | mix chamber setup |
| 202 | pipe |
| 204 | syringe |
| 206 | quick-turn connectors |
| 300 | variable length helical static mix rod |
| 400A | smaller nozzle cross section (e.g., 1 mm nozzle cross-section) |
| 400B | larger nozzle cross section (e.g., 3 mm nozzle cross-section) |
| 500 | excess flow |
| 600 | method to determine a useable resin system |
| 700 | density test setup |
| 702 | PX printed specimen |
| 704 | apparatus |
| 706 | upper frame member |
| 708 | base/support |
| 800 | nonrigid, plastic specimen for tensile tests (type IV) |
| 900 | load frame |
| 902 | load cell |
| 1000 | EPL 4 cast tensile results |
| 1100 | EPL 4 printed tensile results |
| 1200 | PX cast tensile results |
| 1300 | PX ideal tensile results |
| 1400 | PX non-ideal tensile results |
| 1500 | nonrigid, plastic specimen for flexural tests |
| 1600 | 3-point bend setup |
| 1700 | EPL 4 cast flexural results |
| 1800 | EPL 4 printed flexural results |
| 1900 | PX cast tensile results |
| 2000 | PX printed tensile results |
| 2100 | thermogravimetric analysis (TGA) apparatus |
| 2200 | EPL 4 cast TGA results for first specimen |
| 2300 | EPL 4 cast TGA results for second specimen |
| 2400 | EPL 4 cast TGA results for third specimen |
| 2500 | EPL 4 printed TGA results for first specimen |
| 2600 | EPL 4 printed TGA results for second specimen |
| 2700 | EPL 4 printed TGA results for third specimen |
| 2800 | PX cast TGA results for first specimen |
| 2900 | PX cast TGA results for second specimen |
| 3000 | PX cast TGA results for third specimen |
| 3100 | PX printed TGA results for first specimen |
| 3200 | PX printed TGA results for second specimen |
| 3300 | PX printed TGA results for third specimen |
| 3400 | differential scanning calorimetry (DSC) test apparatus |
| 3500 | EPL 4 cast DSC results for first specimen |
| 3600 | EPL 4 cast DSC results for second specimen |
| 3700 | EPL 4 cast DSC results for third specimen |
| 3800 | EPL 4 printed DSC results for first specimen |
| 3900 | EPL 4 printed DSC results for second specimen |
| 4000 | EPL 4 printed DSC results for third specimen |
| 4100 | PX cast DSC results for first specimen |
| 4200 | PX cast DSC results for second specimen |
| 4300 | PX cast DSC results for third specimen |
| 4400 | PX printed DSC results for first specimen |
| 4500 | PX printed DSC results for second specimen |
| 4600 | PX printed DSC results for third specimen |
| 4700 | PX cast specimen |
| 4702 | voids |
| 4800G | G-code path |
| 4800-1 | PX print specimen (first example) |
| 4800-2 | PX print specimen (second example) |
| 4800-3 | PX print specimen (third example) |
| 4900 | maximum tensile stress |
| 5000 | tensile stress versus strain curve |
| 5100 | elastic modulus values |
| 5200 | representative stress versus strain curve |
| 5300 | stress versus strain curve |
| 5400 | captured image |
| 5500 | bar graph showing the maximum flexural stress |
| 5600 | photo of a PX printed specimen after deformation |
| | from flexural testing |
| 5602 | PX printed specimen after deformation from flexural testing |
| 5700 | flexural modulus results |
| 5800 | TGA graph |
| 5900 | DSC graph |
| 6000 | continuous carbon fiber print |
| 6100 | z-reinforced bed |
| 6102 | natural fibers (e.g., ixtle fibers) |
| 6200 | z-reinforced uniformly spaced bed |
| 6300 | venturi nozzle |
| 6302 | nozzle entry |
| 6304 | nozzle exit |
| 6306 | fiber reinforcement flow |
| 6308 | mixed resin flow |
| 6400 | pipe |
| 6500 | venturi system |
| 6600 | nonrigid, plastic specimen for tensile tests (type I) |
| 6700 | print set-up |
| 6800 | G-Code pattern |
| 6900A | static mixing system (e.g., Koflo inline static mixer) |
| 6900B | static mixing system (e.g., SLA printed static mixer) |
| 7000-1 | 2-mm nozzle |
| 7000-2 | 3-mm nozzle |
| 7100 | carbon fiber floating on top |
| 7200 | encapsulated carbon fiber |
| 7300 | grid for multilayer samples |
| 7400 | composites experienced significant fiber pullout |
| 7500 | four-node nozzle |
| 7502 | nozzle entry |
| 7504 | nozzle exit |
| 7506 | fiber reinforcement flow |
| 7508 | mixed resin flow |
| 7510 | node |
| 7600 | eight-node nozzle end |
| 7610 | node |
| 7700 | encapsulation of fiber tows |
| 7800 | observable improvement |
| 7900 | flexural strength improvements of printed specimens |
| 8000 | flexural modulus improvements of printed specimens |
| 8100 | tensile strength improvements of printed specimens |
| 8200 | tensile modulus improvements of printed specimens |
| 8300 | nozzle |
| 8302 | nozzle entry |
| 8304 | nozzle exit |
| 8306 | fiber reinforcement flow |
| 8308 | mixed resin flow |
| 8310 | node |
| 8400A | print using venturi nozzle |
| 8400B | print using the venturi nozzle with massage nodes |
| VARTM | vacuum assisted resin transfer molding |
| PX | pentaerythritol and m-xylylenediamine |
| π | pi |
| r₁ | radius at exit of nozzle |
| H | head speed rate |
| D₁ | density of polymer |
| a | dry mass of the polymer |
| b₁ | apparent mass of the fully immersed polymer |
| ρ_{W} | density of water |
| E | modulus of elasticity |
| σ_{T} | tensile stress |
| ε_{T} | tensile strain |
| R | crosshead rate |
| L | Support span |
| D | depth of beam |
| D | midspan deflection |
| R | strain |
| σ_{F} | flexural stress |
| E_{F} | chord modulus |
| σ_{fn} | flexural stress at predefined point |
| ε_{fn} | flexural strain at predefined point |

### Glossary

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

In materials science, a “thermosetting polymer”, often called a thermoset, is a polymer that is obtained by irreversibly hardening (“curing”) a soft solid or viscous liquid prepolymer (resin). Curing can be induced by heat or suitable radiation and may be promoted by high pressure or mixing with a catalyst. Heat need not necessarily be applied externally and is often generated by the reaction of the resin with a curing agent (catalyst, hardener). Curing results in chemical reactions that create extensive cross-linking between polymer chains to produce an infusible and insoluble polymer network.

“3D printing,” also referred to as “additive manufacturing,” is the construction of a three-dimensional object from a CAD model or a digital 3D model. Additive manufacturing can be accomplished in a variety of processes in which material is deposited, joined or solidified under computer control, with the material being added together (such as plastics, liquids or powder grains being fused), typically layer by layer. 3D printing can be used to produce very complex shapes or geometries that would be otherwise infeasible to construct by hand, including hollow parts or parts with internal truss structures to reduce weight while creating less material waste.

A composite, also referred to as a composite material, is a material which is produced from two or more constituent materials. The constituent materials typically have dissimilar chemical or physical properties and are merged to create a material with properties unlike the individual elements. Within the finished structure, the individual elements remain separate and distinct, distinguishing composites from mixtures and solid solutions. Composite materials with more than one distinct layer are called composite laminates.

Fiber-reinforced materials, as used herein, are materials containing fibrous material which increases their structural integrity. Fibrous materials can comprise short discrete fibers that are uniformly distributed and randomly oriented. Said fibers can include steel fibers, glass fibers, synthetic fibers and natural fibers—each of which can lend varying properties to the material. In addition, the character of fiber-reinforced materials changes with varying materials, fiber materials, geometries, distribution, orientation, and densities.

What is claimed is:

1. A 3D printer comprising:
a liquid injection nozzle comprising a nozzle entry, an inlet hole for an introduction of fiber reinforcement, a chamber for moving a flow of mixed reactive resin, and a nozzle exit; and
a print bed that allows for z-direction reinforcement.

2. The 3D printer of claim 1 wherein the print bed allows for x-direction and y-direction reinforcement.

3. The 3D printer of claim 1 further comprising a resin delivery tip that can be guided through while printing a thermoset resin and/or continuous fiber.

4. The 3D printer of claim 1 wherein the print bed comprises natural fibers.

5. The 3D printer of claim 4 wherein the natural fibers comprise ixtle fibers.

6. The 3D printer of claim 1 wherein the print bed is a z fiber reinforced bed with continuous carbon fiber printed on top.

7. The 3D printer of claim 1, wherein reinforced 3D composites printed using said 3D printer exhibit a quantifiable improvement in tensile strength over that of non-reinforced 3D composites.

8. The 3D printer of claim 1, wherein reinforced 3D composites printed using said 3D printer exhibit a quantifiable improvement in flexural strength over that of non-reinforced 3D composites.

9. The 3D printer of claim 1, wherein reinforced 3D composites printed using said 3D printer exhibit a quantifiable improvement in a thermal degradation temperature over that of non-reinforced 3D composites.

10. The 3D printer of claim 1, wherein reinforced 3D composites printed using said 3D printer exhibit a quantifiable improvement in a viscoelastic property over that of non-reinforced 3D composites.

11. The 3D printer of claim 10, wherein the viscoelastic property comprises a glass transition temperature.

12. The 3D printer of claim 10, wherein the viscoelastic property comprises a loss and storage modulus.

13. The 3D printer of claim 1, wherein reinforced 3D composites printed using said 3D printer exhibit a quantifiable improvement in a degree of curing over that of non-reinforced 3D composites.

14. The 3D printer of claim 1, wherein the 3D printer dispenses two resins in approximately a 1:1 volume ratio into a static mixer attached to a bottom of the 3D printer, and further wherein a liquid injection nozzle is located at an end of the static mixer.

15. The 3D printer of claim 1, wherein the 3D printer prints 3D composites utilizing G-codes that are designed to construct multiple layers and form walls.

16. The 3D printer of claim 15, wherein (i) the walls act as a barrier to hold fiber while taking turns, (ii) the walls are spaced apart a width of the bead that includes the fiber, and (iii) upon completion of the neat resin print, the ends of neat lines are cut off.

17. A three-dimensional (3D) printing reinforcement nozzle for improved fiber wetout, the nozzle comprising:
a low-pressure region to introduce and pull the reinforcement fiber from an inlet into a fluid stream of mixed reactive resin;
a positive pressure region adjacent a nozzle tip;
wherein the low-pressure region prevents the back flow of mixed reactive resin.

18. The 3D printing reinforcement nozzle of claim 17, wherein the reinforcement fiber becomes fully impregnated with the mixed reactive resin in the positive pressure region before being dispensed on the print bed.

19. The 3D printing reinforcement nozzle of claim 17, further comprising a plurality of nodes to aid in moving the fiber and effectively massaging the resin into the tow and improve wetout.

20. A reinforced, printed specimen printed using the 3D printing reinforcement nozzle of claim 17, wherein basalt and fiberglass are introduced into the specimen.
